(19) United States
(12) Patent Application Publication
(10) Pub. No.: US 2026/0156471 A1
(43) Pub. Date: Jun. 4, 2026

(54) INFORMATION PROCESSING METHOD, INFORMATION PROCESSING APPARATUS, AND INFORMATION PROCESSING SYSTEM

(71) Applicant: SONY GROUP CORPORATION, TOKYO (JP)

(72) Inventors: HIROAKI TAKANO, TOKYO (JP); HIROTO KURIKI, TOKYO (JP); HIROFUMI KASAI, TOKYO (JP)

(21) Appl. No.: 18/706,762

(22) PCT Filed: Oct. 25, 2022
(86) PCT No.: PCT/JP2022/039658

§ 371 Date: May 2, 2024

(30) Foreign Application Priority Data
Nov. 10, 2021 (JP) 2021-183483

(51) Int. Cl. H04W 12/086

(52) U.S. Cl. CPC H04W 12/086

(57) ABSTRACT

An information processing method is an information processing method executed by an information processing apparatus that manages closed network communication of a plurality of non-public cellular closed networks connected by secure communication, in which each of the plurality of non-public cellular closed networks includes a gateway that performs an operation related to restriction of the closed network communication based on a notification from the information processing apparatus, the method including the step of, by the information processing apparatus, notifying the gateway of at least one closed network of two non-public cellular closed networks performing the closed network communication of restriction of the closed network communication.

### FIELD

The present disclosure relates to an information processing method, an information processing apparatus, and an information processing system.

### BACKGROUND

In recent years, a private network using cellular wireless communication has attracted attention. The communication device in the private network can communicate not only with other communication devices in the private network but also with communication devices outside the private network (for example, a communication device in another private network).

### CITATION LIST

### Patent Literature

Patent Literature 1: JP 2021-052346 A

### SUMMARY

### Technical Problem

However, in a case where communication is performed between different private networks, the communication device communicates with the communication device on the counterpart side via the public network. Therefore, it is difficult to perform communication between different private networks while maintaining the strength of security.

Therefore, the present disclosure proposes an information processing method, an information processing apparatus, and an information processing system capable of realizing communication between private networks with high security strength.

Note that the above problem or object is merely one of a plurality of problems or objects that can be solved or achieved by the plurality of embodiments disclosed in the present specification.

### Solution to Problem

In order to solve the above problem, an information processing method according to one embodiment of the present disclosure executed by an information processing apparatus that manages closed network communication of a plurality of non-public cellular closed networks connected by secure communication, wherein each of the plurality of non-public cellular closed networks includes a gateway that performs an operation related to restriction of the closed network communication based on a notification from the information processing apparatus, the method comprising the step of: by the information processing apparatus, notifying the gateway of at least one closed network of two non-public cellular closed networks performing the closed network communication of restriction of the closed network communication.

### BRIEF DESCRIPTION OF DRAWINGS

FIG. 1 is a diagram illustrating an example of a private network.

FIG. 2 is a diagram illustrating a communication system in a case where there is another 4G/5G private network.

FIG. 3 is a diagram illustrating a communication system in a case where there is a plurality of other 4G/5G private networks.

FIG. 4 is a diagram illustrating an overview of solutions of the present embodiment.

FIG. 5 is a diagram illustrating a configuration example of a communication system according to the embodiment of the present disclosure.

FIG. 6 is a diagram illustrating a configuration example of a management device according to the embodiment of the present disclosure.

FIG. 7 is a diagram illustrating a configuration example of a base station according to the embodiment of the present disclosure.

FIG. 8 is a diagram illustrating a configuration example of a terminal device according to the embodiment of the present disclosure.

FIG. 9 is a diagram illustrating a configuration example of a network management device according to the embodiment of the present disclosure.

FIG. 10 is a diagram illustrating an example of 5G architecture.

FIG. 11 is a diagram illustrating an example of 4G architecture.

FIG. 12 is a sequence diagram illustrating a connection procedure of two private networks.

FIG. 13 is a sequence diagram illustrating a procedure of connection and disconnection of two private networks.

FIG. 14 is a diagram for explaining solutions of a second embodiment.

FIG. 15 is a diagram illustrating an example of an operation of a communication system 1 of the second embodiment.

FIG. 16 is a diagram illustrating another example of the operation of the communication system 1 of the second embodiment.

FIG. 17 is a diagram illustrating another example of the operation of the communication system 1 of the second embodiment.

FIG. 18 is a diagram illustrating another example of the operation of the communication system 1 of the second embodiment.

FIG. 19 is a diagram illustrating another example of the operation of the communication system 1 of the second embodiment.

FIG. 20 is a diagram illustrating another example of the operation of the communication system 1 of the second embodiment.

### DESCRIPTION OF EMBODIMENTS

Hereinafter, embodiments of the present disclosure will be described in detail with reference to the drawings. In each of the following embodiments, the same parts are denoted by the same reference numerals, and redundant description will be omitted.

Furthermore, in the specification and the drawings, a plurality of constituent elements having substantially the same functional configuration may be distinguished from one another by adding different numbers after the same reference numeral. For example, a plurality of configurations having substantially the same functional configuration is distinguished as terminal devices 301, 302, and 303 as necessary. However, if it is not necessary to distinguish the plurality of constituent elements having substantially the same functional configuration from one another, only the same reference numeral is given. For example, in a case where it is not necessary to particularly distinguish the terminal devices 301, 302, and 303, they are simply referred to as terminal devices 30.

Each of the one or the plurality of embodiments (examples and modifications) described below can be implemented independently. On the other hand, the plurality of embodiments described below may be implemented at least partially in appropriate combination with at least some of other embodiments. The plurality of embodiments may include novel features that are different from one another. Therefore, the plurality of embodiments can contribute to solving different objects or problems, and can exhibit different effects.

Note that the description will be given in the following order.

Further, the present disclosure will be described according to the following order of items.
1. Overview
1-1. Local 5G/Private 5G
1-2. Features of Private Network
1-3. Coordination of Multiple Private Networks
1-4. Overview of Problems and Solutions of Present Embodiment
2. Configuration of Communication System
2-1. Overall Configuration of Communication System
2-2. Configuration of Management Device
2-3. Configuration of Base Station
2-4. Configuration of Terminal Device
2-5. Configuration of Network Management Device
3. Network Architecture
3-1. Configuration Example of 5G Network Architecture
3-2. Configuration Example of 4G Network Architecture
4. First Embodiment
4-1. Problem
4-2. First Solution
4-3. Second Solution
5. Second Embodiment
5-1. Problem
5-2. First Solution
5-3. Second Solution
5-4. Third Solution
5-5. Fourth Solution
6. Modification
7. Conclusion

### 1. Overview

In recent years, private networks such as local 5G and private 5G have attracted attention. The private network is also referred to as a non-public network.

### 1-1. Local 5G/Private 5G

The local 5G and the private 5G are services of cellular communication performed in a limited area such as a factory, an office, a studio, a hospital, or a university. By limiting the service provision to a local area, there is an advantage that a customized cellular service can be provided. In the present embodiment, the private 5G and the local 5G may be referred to as a 4G/5G private network or a 4G/5G virtual private network. Note that the private network is not limited to the 4G/5G private network. In the following description, the private network may be referred to as a non-public cellular closed network or simply a closed network.

Security is emphasized in many use cases. For example, in a factory, there is a case where a technique is handled with high confidentiality such as a production line of the factory. In a hospital or the like, personal information regarding privacy of a patient is often handled, and thus, this is a use case with high confidentiality. Also in universities and offices, personal information is often handled, and communication related to the personal information is required to have high confidentiality.

### 1-2. Features of Private Network

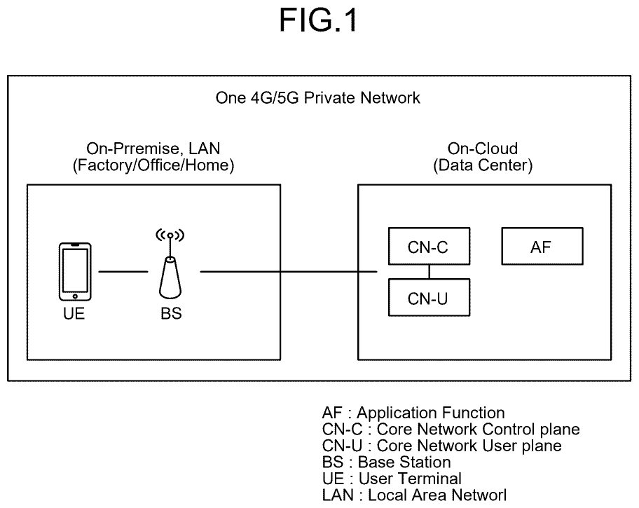

Prior to a description of an overview of the present embodiment, features of the private network will be described. FIG. 1 is a diagram illustrating an example of a private network.

### (1) Properties of Closed Network

In the private network, a LAN and a cloud are connected in a closed network. The closed network is, for example, a virtual private network (VPN). In a closed network, a base station disposed in a LAN and a core network arranged in a cloud are connected using a private IP address without using a public IP address. In a case where communication is performed only in a closed network, it is resistant to eavesdropping from the outside and the like. It can set up to block any access from outside the closed network, or it can also set up to send a packet from inside the closed network to the outside and only the response is allowed to come into the closed network. In general, it is not possible to access a device or a terminal device in a closed network by applying a trigger from the outside the closed network, and thus, it can be said that the secrecy of the closed network is high.

Since translation between a private IP address and a global IP address is not required, user datagram protocol (UDP) communication can be easily used. Because a transmission control protocol (TCP) is usually used when a translation is required, a feature that UDP communication is easy to use is attractive for an application using UDP communication. When UDP is used, there is an advantage that a delay is small.

### (2) IP Address Assigned to Terminal Device

When the terminal device attaches to the network, an IP address is given from the core network to the terminal device. Usually, a private IP address is given. In the case of a public network, a public IP address may be directly assigned to a terminal device, but in a 4G/5G private network which is a non-public network, a private IP address is usually assigned to a terminal device. Therefore, when going out from the closed network, the private IP address is translated into the public IP address by the network address translation (NAT translation).

It is possible to acquire the information on the IP address assigned to the terminal device from the core network. In 5G, an application program interface (API) called service based interface (SBI) for acquiring an IP address of a terminal device is prepared. Even in the 4G, the IP address of the terminal device can be acquired similarly to the 5G by accessing a subscriber file storing the IP address for each terminal device.

In the closed network, by holding the IP address of the terminal device, it is possible to directly transmit an IP packet to the terminal device from an application function (AF) side (that is, network initiated message push).

### 1-3. Coordination of Multiple Private Networks

In the present embodiment, consideration is given to communication between different private networks. For example, a case of connecting a plurality of 4G/5G private networks over the Internet will be considered. In this case, since a packet is once sent to the public Internet, a security threat increases. It is not desirable for security to directly transmit the IP address of the terminal device to the counterpart. In addition, since a private IP address is translated into a public IP address once when going out to the Internet, a problem of network address translation (NAT) crossing occurs. Therefore, direct communication of UDP is difficult.

Note that, in a normal cellular system, when a packet is transmitted to a terminal device by specifying an IP address from outside the cellular network, the packet may directly arrive, but there may be a case where the packet does not directly arrive. Although it is limited to a case where the communication business operator has a lot of global IP addresses, if the global IP address is directly allocated to the terminal device, it is possible to directly send a packet to the global IP address from the outside. However, it can be said that this depends on a security policy. If a packet can be directly sent, there is a risk that undesired traffic flows in from the outside, and therefore such a packet is not allowed in most cases. That is, since the security threat is large, the degree of freedom may be reduced when the countermeasure is taken. It is not desirable for security to directly transmit the IP address of the terminal device to the counterpart. In the case of cellular, there is also a problem that the cost of the cellular network is higher than that of the 4G/5G private network. Therefore, it will be important in the future to prepare a plurality of 4G/5G private networks and directly connect the 4G/5G private networks through a VPN tunnel.

Therefore, hereinafter, a case where different private networks are connected by a VPN tunnel will be considered.

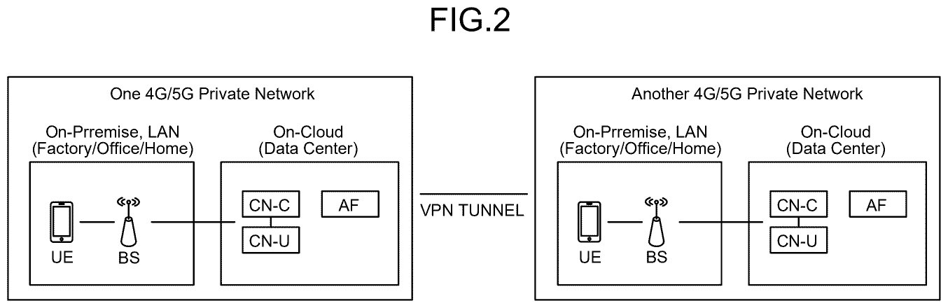

FIG. 2 is a diagram illustrating a communication system in a case where there is another 4G/5G private network. In the example of FIG. 2, two 4G/5G private networks are directly connected by tunneling of the VPN. Since the closed networks are connected to each other, in the closed networks, the packet can be transmitted to the terminal device or the client application on the counterpart side with the private IP address.

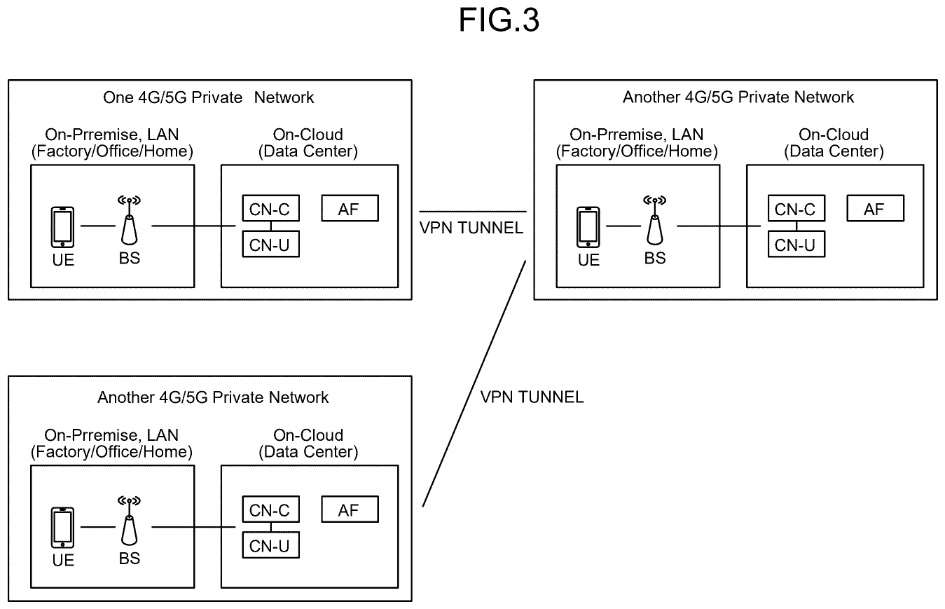

FIG. 3 is a diagram illustrating a communication system in a case where there is a plurality of 4G/5G private networks of counterparts. In a case where there are a plurality of counterparts, as illustrated in FIG. 3, VPN tunnels are set with the plurality of counterparts. The star connection is not desirable because there is a large influence when a failure occurs in a switch in the center. In the case of the 1:1 pairing, since the information is spread only to the counterpart, this topology is desirable also from the viewpoint of security.

Note that a method of connecting a plurality of 4G/5G private networks by secure communication is not limited to a method using a virtual private network (VPN) tunnel. As a method of connecting a plurality of 4G/5G private networks by secure communication, for example, a method of connecting by a dedicated line is conceived.

Here, consideration is given to a use case of a network in which a plurality of 4G/5G private networks is coordinated. The following is conceived as a use case.

### (1) Internet of Things (IoT)

There is a request to arrange IoT devices under a 4G/5G private network, control the IoT devices by an information processing device, and extract information from the IoT devices. In this case, there is an issue in which if the IoT devices in one 4G/5G private network are simply controlled to acquire information, the number of IoT sensors is limited, resulting the shortage in scale as an IoT system. Therefore, there is a need for collecting the information by coordinating a plurality of private networks. In this case, the locations of the IoT devices to communicate with are known in advance in many cases. Since the TCP connection tends to impose a heavy load of power consumption on the IoT devices, there is a demand for communication by UDP.

### (2) Game

In playing a network game, it may be recalled that the counterpart belongs to a different 4G/5G private network. In this case, since the counterpart with which communication is desired is the one determined by the server of the game, it is often not known until immediately before the game to which counterpart communication is performed. In this case, it is considered that it is often desired to perform communication by UDP rather than TCP due to delay constraints.

### (3) Remote Monitoring

There may be a case of desiring to monitor a video from a remote camera. In the case of a video such as VR, a large capacity and a low delay may be required. It is desirable from the viewpoint of security that communication can be performed between 4G/5G private networks when the monitoring video is very important information.

### (4) Others

The plurality of private networks may be owned by different business operators. It is desirable that one business operator perform network management of a plurality of private networks, but clients using the private networks are different. For example, it is assumed that there are a client A who measures using an IoT sensor that can measure wind power in Japan and a customer B who measures wind power in Europe using an IoT sensor. Then, it is assumed that the terminal device of the client A is connected to a private network A, and the terminal device of the client B is connected to a private network B. At this time, it is assumed that a business operator C needs to collect information from the terminal devices of the clients A and B using the terminal devices connected to a private network C. In this case, it is considered that the business operator C wants to connect the private networks A and B.

### 1-4. Overview of Problems and Solutions of Present Embodiment

Based on the above, an outline of problems and solutions of the present embodiment will be described.

### 1-4-1. Attacks from Malicious Users in Closed Network

When a plurality of private networks is not coordinated (that is, when only one private network is used), security threats are often small. This is because the user who connects to the network is limited to the user who uses the private network.

On the other hand, in a case where a plurality of private networks is coordinated, a security threat increases in many cases. This is because, for a user using a certain private network A, a user in another private network B is not necessarily a safe user. When the private networks are coordinated, it cannot exclude a possibility that a user in one private network attacks another user by sending a large amount of IP packets to user equipment (UE)/application function (AF)/network function (NF) in another private network, or by spoofing or eavesdropping.

To reduce security threats, only IP packets from accepted users need to be allowed inside the private network. That is, even if the private network A and the private network B are connected, it is necessary to prevent an IP packet of an unaccepted user in the private network B from intruding into the private network A.

### 1-4-2. MAC Filtering and IP Filtering

One of the methods of allowing only an IP packet of an accepted user to enter inside a network is MAC filtering. MAC filtering is a method in which a gateway at an entry point of a network accepts entry into the network only for an IP packet carried in a packet having an accepted MAC address. However, since the MAC address can be rewritten to an arbitrary value, the MAC filtering is not sufficient as a security measure.

Another method of allowing only an IP packet of an accepted user to enter inside a network is IP filtering. IP filtering is a method in which a gateway at an entry point of a network accepts entry into the network only for an IP packet having an IP address in a designated IP address range as a source IP address. This IP filtering can be said to be a method superior to MAC filtering as a security measure. This is because, even if a packet is transmitted by falsifying the source IP address, a router on the way to the destination clearly notices that the falsified source IP address is not appropriate, therefore the falsification of the IP address cannot be practically performed.

When using IP filtering, IP packets with unaccepted IP addresses cannot enter inside the network. Usually, an IP filter is performed with a source IP address, but it is also possible to perform the IP filter with a destination IP address. Although an inbound IP filtering entering from outside the network is important, it is also possible to perform an outbound IP filtering exiting from inside the network. Although the present embodiment has been described focusing on an inbound IP filter, the present embodiment is also applicable to an outbound IP filter.

### 1-4-3. IP Filtering Problems

In a 4G/5G private network, the IP address assigned to the UE may change. For example, when the UE detaches from the network and attaches again, another IP address is assigned to the UE. Even if it is desired to accept only a packet of a specific UE (referred to as UE B) of the private network B to enter inside the private network A, the IP address of the UE B may be changed to any IP address in the IP address range assigned to the private network B, therefore the purpose cannot be achieved by simply adopting IP filtering.

It is also conceivable that all the IP addresses in the IP address range assigned to the private network B are IP addresses that can enter the private network A. However, since this is the same as accepting packets of all UEs in the private network B to enter, the possibility of being attacked by a dangerous UE cannot be excluded. When IP filtering is applied to the private network, consideration is needed for the possibility that the IP address of the UE targeted for the IP filter is changed.

In addition, in the private network B, not only the UE but also an application function (AF) exists. The IP address of the AF is automatically assigned corresponding to the subnetwork to the AF in which a cloud system is arranged in a subnetwork. It is also a problem how to perform IP filtering on the IP addresses of AF to be accepted and AF to be unaccepted.

### 1-4-4. Overview of Solution

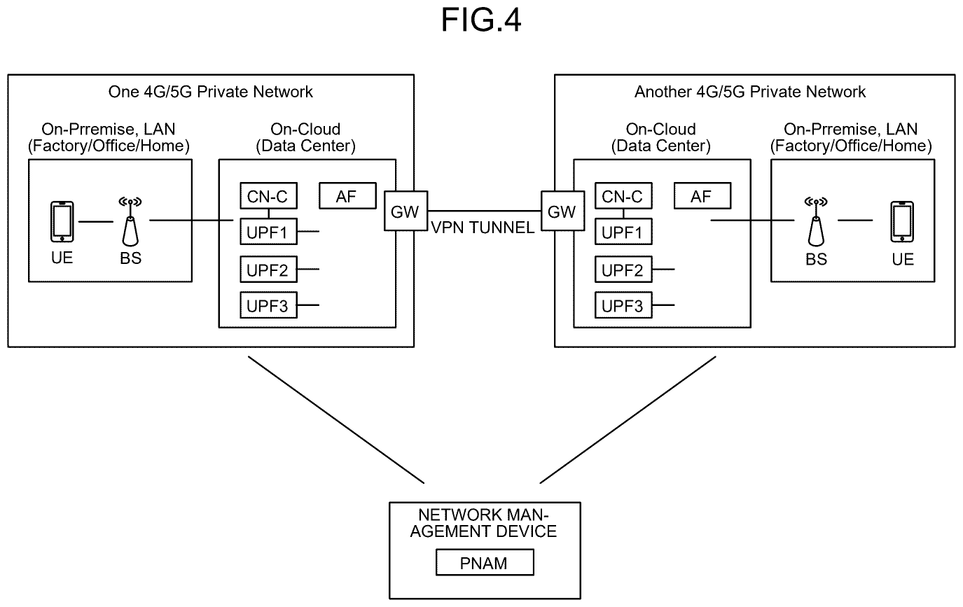

FIG. 4 is a diagram illustrating an overview of solutions of the present embodiment. In the present embodiment, a network management device connected to a plurality of private networks is arranged on a public network. The network management device has private network association management (PNAM) which is a management function for managing the plurality of private networks. The plurality of private networks are connected by secure communication (for example, a VPN tunnel), and a gateway that performs an operation related to restriction on closed network communication based on a notification from the management function is arranged in each of the plurality of private networks. Here, the closed network communication is communication between private networks that communicate with nodes of other private networks beyond the private network to which the own network belongs. The management function of the network management device notifies the gateway of at least one of the two private networks performing the closed network communication of the restriction on the closed network communication.

For example, when the management function of the network management device acquires information of a request for access from a node (for example, UE or AF) belonging to one private network of the two private networks to a node (for example, UE or AF) belonging to the other private network, the management function determines whether or not to accept access according to a predetermined criterion. The information of the access request may include an IP address of the source node. The management function then notifies the gateway of at least one of the two private networks of this determination. The gateway operates so that only a node accepted to access can perform closed network communication. For example, the gateway performs IP filtering so that an IP packet having an IP address of a source node can enter the private network. By determining whether or not to accept access each time an access request is made, unnecessary connection can be reduced. As a result, security threats can be reduced.

Note that a plurality of IP address pools may be assigned to the private network. For example, a plurality of user plane functions (UPFs) in which different IP address pools are set may be arranged in the private network. At this time, the plurality of IP address pools may include at least one IP address pool used for closed network communication. Then, the management function of the network management device may notify the gateway to perform IP filtering based on information of an IP address range (hereinafter, referred to as a predetermined IP address range) associated with an IP address pool used for closed network communication. The gateway performs IP filtering based on the notification from the management function so that only IP packets in a predetermined IP address range can enter the private network. As a result, even if an IP address of the node accepted to perform the closed network communication is changed to another IP address, the IP filtering functions as long as the IP address is within a predetermined address range. Therefore, security threats can be reduced with less signaling.

### 2. Configuration of Communication System

The outline of the present embodiment has been described above, and before the present embodiment is described in detail, the configuration of a communication system 1 including the information processing apparatus of the present embodiment will be described. Note that the communication system can be rephrased as an information processing system.

### 2-1. Overall Configuration of Communication System

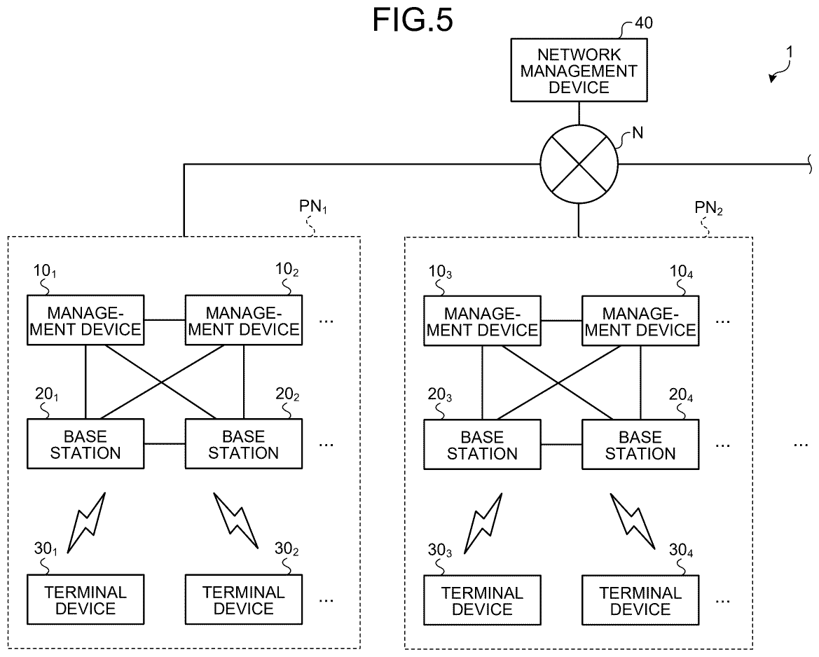

FIG. 5 is a diagram illustrating a configuration example of the communication system 1 according to the embodiment of the present disclosure. The communication system 1 includes a plurality of private networks PN. The private network PN is, for example, a private network using cellular wireless communication such as 4G or 5G. The plurality of private networks PN is connected via a network N. Although only one network N is illustrated in the example of FIG. 5, a plurality of networks N may exist.

Here, the network N is, for example, a public network such as the Internet. Note that the network N is not limited to the internet, and may be, for example, a local area network (LAN), a wide area network (WAN), a cellular network, a fixed-line network, or a regional Internet protocol (IP) network. The network N may include wired or wireless networks.

In each of the plurality of private networks PN, a management device 10, a base station 20, and a terminal device 30 are arranged. In addition, the plurality of private networks PN is connected to a network management device 40 via a network N. The communication system 1 provides the user with a wireless network capable of mobile communication by the wireless communication devices constituting the communication system 1 operating in cooperation. The wireless network of the present embodiment includes, for example, a radio access network and a core network. Note that, in the present embodiment, the wireless communication device is a device having a function of wireless communication, and corresponds to the base station 20 and the terminal device 30 in the example of FIG. 5.

The communication system 1 may include a plurality of management devices 10, a plurality of base stations 20, a plurality of terminal devices 30, and a plurality of network management devices 40. In the example of FIG. 5, the communication system 1 includes management devices 101 and 102 as the management device 10, and includes base stations 201 and 202 as the base station 20. Furthermore, the communication system 1 includes terminal devices 301, 302, 303, and the like as the terminal device 30.

Note that the devices in the drawings may be considered as devices in a logical sense. That is, a part of the device in the drawing may be realized by a virtual machine (VM), a container, a docker, or the like, and they may be implemented on physically the same hardware.

Note that the communication system 1 may support a radio access technology (RAT) such as long term evolution (LTE) or new radio (NR). LTE and NR are types of cellular communication technology, and enable mobile communication of a terminal device by arranging a plurality of areas covered by a base station in a cell shape. Note that the radio access scheme used by the communication system 1 is not limited to LTE and NR, and may be another radio access scheme such as wideband code division multiple access (W-CDMA) or code division multiple access 2000 (cdma 2000).

Furthermore, the base station or the relay station constituting the communication system 1 may be a ground station or a non-ground station. The non-ground station may be a satellite station or an aircraft station. If the non-ground station is a satellite station, the communication system 1 may be a bent-pipe (transparent) type mobile satellite communication system.

In the present embodiment, the ground station (also referred to as a ground base station) refers to a base station (including a relay station) installed on the ground. Here, the “ground” is a ground in a broad sense including not only land but also in the ground, on the water, and under the water. Note that, in the following description, the description of “ground station” may be replaced with “gateway”.

Note that an LTE base station may be referred to as an evolved node B (eNodeB) or an eNB. Further, an NR base station may be referred to as a gNodeB or a gNB. In LTE and NR, a terminal device (also referred to as a mobile station or a terminal) may be referred to as user equipment (UE). Note that the terminal device is a type of communication device, and is also referred to as a mobile station or a terminal.

In the present embodiment, the concept of a communication device includes not only a portable mobile device (terminal device) such as a mobile terminal but also a device installed in a structure or a mobile body. A structure or a mobile body itself may be regarded as a communication device. In addition, the concept of a communication device includes not only a terminal device but also a base station and a relay station. The communication device is a type of processing device and information processing device. Furthermore, the communication device can be rephrased as a transmission device or a reception device.

Hereinafter, a configuration of each device constituting the communication system 1 will be specifically described. Note that the configuration of each device described below is merely an example. The configuration of each device may be different from the following configuration.

### 2-2. Configuration of Management Device

Next, a configuration of the management device 10 will be described.

The management device 10 is an information processing device (computer) that manages a wireless network. For example, the management device 10 is an information processing device that manages communication of the base station 20. The management device 10 may be, for example, a device having a function as a mobility management entity (MME). The management device 10 may be a device having a function as an access and mobility management function (AMF) and/or a session management function (SMF). Of course, the functions of the management device 10 are not limited to the MME, the AMF, and the SMF. The management device 10 may be a device having a function as a network slice selection function (NSSF), an authentication server function (AUSF), a policy control function (PCF), or a unified data management (UDM). Furthermore, the management device 10 may be a device having a function as a home subscriber server (HSS). In addition, the management device 10 may have private network association management (PNAM) which is a management function provided in the network management device 40 and function as the network management device 40.

Note that the management device 10 may have a function of a gateway. For example, the management device 10 may have a function as a serving gateway (S-GW) or a packet data network gateway (P-GW). In addition, the management device 10 may have a function of a user plane function (UPF). At this time, the management device 10 may have a plurality of UPFs. Furthermore, the management device 10 may have a function of private network association management (PNAM).

The core network includes a plurality of network functions, and each network function may be aggregated into one physical device or distributed to a plurality of physical devices. That is, the management device 10 can be distributed and arranged in a plurality of devices. Further, this distributed arrangement may be controlled to be performed dynamically. The base station 20 and the management device 10 constitute one network, and provide a wireless communication service to the terminal device 30. The management device 10 is connected to the Internet, and the terminal device 30 can use various services provided via the Internet via the base station 20.

Note that the management device 10 is not necessarily a device constituting the core network. For example, it is assumed that the core network is a core network of wideband code division multiple access (W-CDMA) or code division multiple access 2000 (cdma 2000). At this time, the management device 10 may be a device that functions as a radio network controller (RNC).

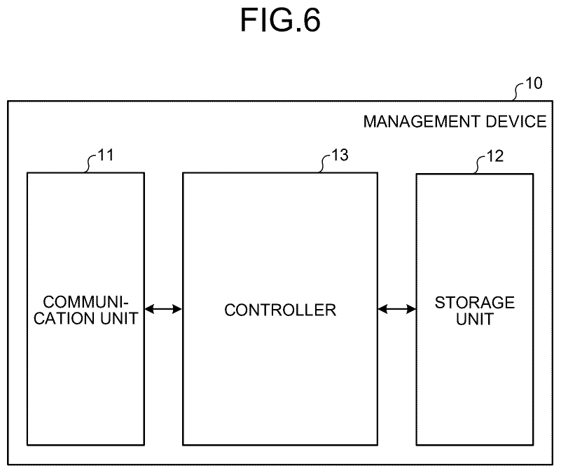

FIG. 6 is a diagram illustrating a configuration example of the management device 10 according to the embodiment of the present disclosure. The management device 10 includes a communication unit 11, a storage unit 12, and a controller 13. Note that the configuration illustrated in FIG. 6 is a functional configuration, and the hardware configuration may be different from this functional configuration. Furthermore, the functions of the management device 10 may be implemented in a statically or dynamically distributed manner in a plurality of physically separated configurations. For example, the management device 10 may include a plurality of server devices.

The communication unit 11 is a communication interface for communicating with other devices. The communication unit 11 may be a network interface or a device connection interface. For example, the communication unit 11 may be a local area network (LAN) interface such as a network interface card (NIC), or may be a USB interface including a universal serial bus (USB) host controller, a USB port, and the like. Further, the communication unit 11 may be a wired interface or a wireless interface. The communication unit 11 functions as a communication unit of the management device 10. The communication unit 11 communicates with the base station 20 and the like under the control of the controller 13.

The storage unit 12 is a data readable/writable storage device such as a dynamic random access memory (DRAM), a static random access memory (SRAM), a flash memory, or a hard disk. The storage unit 12 functions as a storage unit of the management device 10. The storage unit 12 stores, for example, a connection state of the terminal device 30. For example, the storage unit 12 stores a radio resource control (RRC) state, an EPS connection management (ECM), or a 5G system connection management (CM) state of the terminal device 30. The storage unit 12 may function as a home memory that stores position information of the terminal device 30.

The controller 13 is a controller that controls each unit of the management device 10. The controller 13 is implemented by, for example, a processor such as a central processing unit (CPU), a micro processing unit (MPU), or a graphics processing unit (GPU). For example, the controller 13 is implemented by a processor executing various programs stored in a storage device inside the management device 10 using a random access memory (RAM) or the like as a work area. Furthermore, the controller 13 may be implemented by, for example, an integrated circuit such as an application specific integrated circuit (ASIC) or a field programmable gate array (FPGA). Any of the CPU, the MPU, the GPU, the ASIC, and the FPGA can be regarded as a controller.

### 2-3. Configuration of Base Station

Next, a configuration of the base station 20 will be described.

The base station 20 is a wireless communication device that performs wireless communication with the terminal device 30. The base station 20 may be configured to wirelessly communicate with the terminal device 30 via a relay station, or may be configured to directly wirelessly communicate with the terminal device 30.

The base station 20 is a type of communication device. More specifically, the base station 20 is a device corresponding to a radio base station (base station, Node B, eNB, gNB, etc.) or a wireless access point. The base station 20 may be a wireless relay station. In addition, the base station 20 may be an optical remote device called a remote radio head (RRH) or a radio unit (RU). Furthermore, the base station 20 may be a receiving station such as a field pickup unit (FPU). Furthermore, the base station 20 may be an integrated access and backhaul (IAB) donor node or an IAB relay node that provides a radio access line and a radio backhaul line by time division multiplexing, frequency division multiplexing, or space division multiplexing.

Note that the radio access technology used by the base station 20 may be a cellular communication technology or a wireless LAN technology. Of course, the radio access technology used by the base station 20 is not limited the technologies above, and may be another radio access technology. For example, the radio access technology used by the base station 20 may be a low power wide area (LPWA) communication technology. Of course, the radio communication used by the base station 20 may be radio communication using millimeter waves. In addition, the radio communication used by the base station 20 may be radio communication using radio waves or radio communication (optical radio) using infrared rays or visible light. Furthermore, the base station 20 may be capable of non-orthogonal multiple access (NOMA) communication with the terminal device 30. Here, the NOMA communication is communication using a non-orthogonal resource (transmission, reception, or both). Note that the base station 20 may be able to perform NOMA communication with another base station 20.

Note that the base stations 20 may be able to communicate with each other via a base station to core network interface (For example, NG Interface, S1 Interface, and the like). This interface may be either wired or wireless. Furthermore, the base stations may be capable of communicating with each other via an inter-base-station interface (for example, Xn Interface, X2 Interface, S1 Interface, F1 Interface, and the like). This interface may be either wired or wireless.

Note that the concept of a base station includes not only a donor base station but also a relay base station (also referred to as a relay station). For example, the relay base station may be any one of RF Repeater, Smart Repeater, and Intelligent Surface. In addition, the concept of a base station includes not only a structure having a function of a base station but also a device installed in the structure.

The structure is, for example, a building such as a high-rise building, a house, a steel tower, a station facility, an airport facility, a harbor facility, an office building, a school building, a hospital, a factory, a commercial facility, or a stadium. Note that the concept of a structure includes not only a building but also a construction (non-building structure) such as a tunnel, a bridge, a dam, a wall, or an iron pillar, and equipment such as a crane, a gate, or a windmill. In addition, the concept of a structure includes not only a structure on land (on the ground in a narrow sense) or in the ground, but also a structure on the water such as a platform or a mega-float, and a structure under the water such as a marine observation facility. The base station may be referred to as an information processing apparatus.

The base station 20 may be a donor station or a relay station. Furthermore, the base station 20 may be a fixed station or a mobile station. The mobile station is a wireless communication device (for example, a base station) configured to be movable. At this time, the base station 20 may be a device installed in a mobile body or may be a mobile body itself. For example, a relay station having mobility can be regarded as the base station 20 as a mobile station. In addition, a device that is originally a device having a mobility and has a function of a base station (at least a part of the function of the base station), such as a vehicle, an unmanned aerial vehicle (UAV) typified by a drone, or a smartphone, also corresponds to the base station 20 as a mobile station.

Here, the mobile body may be a mobile terminal such as a smartphone or a mobile phone. In addition, the mobile body may be a mobile body (for example, a vehicle such as an automobile, a bicycle, a bus, a truck, a motorcycle, a train, or a linear motor car) that moves on land (on the ground in a narrow sense) or a mobile body (for example, the subway) that moves in the ground (for example, in the tunnel). In addition, the mobile body may be a mobile body that moves on the water (for example, a ship such as a passenger ship, a cargo ship, or a hovercraft) or a mobile body that moves under the water (for example, underwater vehicles such as submersibles, submarines, and unmanned underwater vehicles). Note that the mobile body may be a mobile body that moves in the atmosphere (for example, an aircraft such as an airplane, an airship, or a drone).

Furthermore, the base station 20 may be a ground base station (ground station) installed on the ground. For example, the base station 20 may be a base station arranged in a structure on the ground, or may be a base station installed in a mobile body moving on the ground. More specifically, the base station 20 may be an antenna installed in a structure such as a building and a signal processing device connected to the antenna. Of course, the base station 20 may be a structure or a mobile body itself. The “ground” is a ground including not only land (a ground in a broad sense) but also in the ground, on the water, and under the water. Note that the base station 20 is not limited to a ground base station. For example, in a case where the communication system 1 is a satellite communication system, the base station 20 may be an aircraft station. From the perspective of a satellite station, an aircraft station located on the earth is a ground station.

Note that the base station 20 is not limited to a ground station. The base station 20 may be a non-ground base station (non-ground station) capable of floating in the air or space. For example, the base station 20 may be an aircraft station or a satellite station.

The satellite station is a satellite station capable of floating outside the atmosphere. The satellite station may be a device mounted on a space mobile body such as an artificial satellite, or may be a space mobile body itself. A space mobile body is a mobile body that moves outside the atmosphere. Examples of the space mobile body include artificial celestial bodies such as satellite stations, spacecraft, space stations, and probes. Note that the satellite serving as the satellite station may be any of a low earth orbiting (LEO) satellite, a medium earth orbiting (MEO) satellite, a geostationary earth orbiting (GEO) satellite, and a highly elliptical orbiting (HEO) satellite. Of course, the satellite station may be a device mounted on a low earth orbiting satellite, a medium earth orbiting satellite, a geostationary earth orbiting satellite, or a highly elliptical orbiting satellite.

An aircraft station is a wireless communication device capable of floating in the atmosphere, such as an aircraft. The aircraft station may be a device mounted on an aircraft or the like, or may be an aircraft itself. Note that the concept of an aircraft includes not only heavy aircraft such as an airplane and a glider but also light aircraft such as a balloon and an airship. In addition, the concept of an aircraft includes not only a heavy aircraft and a light aircraft but also a rotorcraft such as a helicopter and an autogyro. Note that the aircraft station (or an aircraft on which an aircraft station is mounted) may be an unmanned aerial vehicle such as a drone.

Note that the concept of an unmanned aerial vehicle also includes an unmanned aircraft system (UAS) and a tethered UAS. The concept of an unmanned aerial vehicle also includes lighter than air (LTA) UAS and heavy than air (HTA) UAS. Other concepts of unmanned aerial vehicles also include high altitude UAS platforms (HAPs).

The coverage size of the base station 20 may be large such as a macro cell or small such as a pico cell. Of course, the coverage size of the base station 20 may be extremely small such as a femto cell. In addition, the base station 20 may have a beamforming capability. In this case, in the base station 20, a cell or a service area may be formed for each beam.

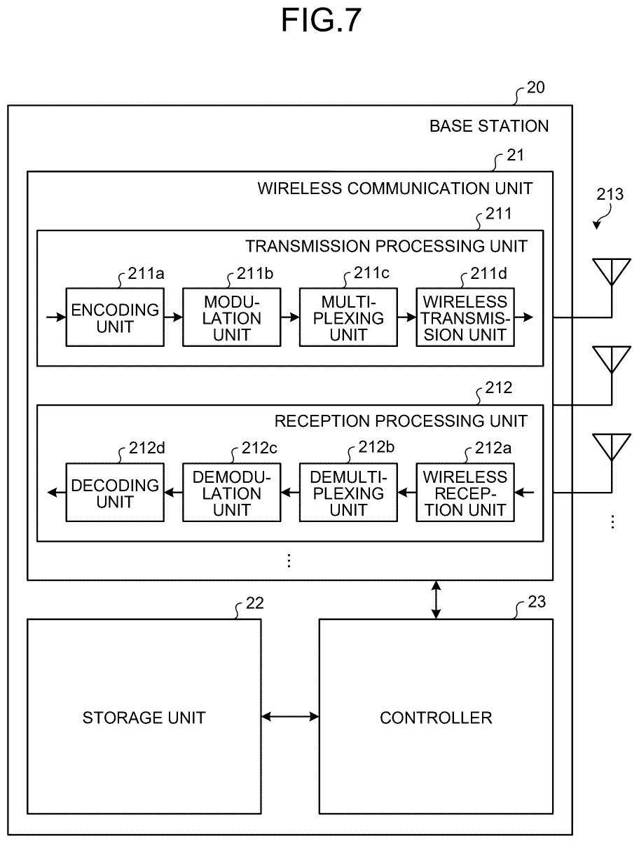

FIG. 7 is a diagram illustrating a configuration example of the base station 20 according to the embodiment of the present disclosure. The base station 20 includes a wireless communication unit 21, a storage unit 22, and a controller 23. Note that the configuration illustrated in FIG. 7 is a functional configuration, and the hardware configuration may be different from this functional configuration. Furthermore, the functions of the base station 20 may be implemented in a distributed manner in a plurality of physically separated configurations.

The wireless communication unit 21 is a signal processing unit for wirelessly communicating with other wireless communication devices (for example, the terminal device 30). The wireless communication unit 21 operates under the control of the controller 23. The wireless communication unit 21 corresponds to one or a plurality of radio access schemes. For example, the wireless communication unit 21 supports both NR and LTE. The wireless communication unit 21 may be compatible with W-CDMA or cdma 2000 in addition to NR or LTE. Furthermore, the wireless communication unit 21 may support an automatic retransmission technology such as hybrid automatic repeat request (HARQ).

The wireless communication unit 21 includes a transmission processing unit 211, a reception processing unit 212, and an antenna 213. The wireless communication unit 21 may include a plurality of the transmission processing units 211, a plurality of the reception processing units 212, and a plurality of the antennas 213. When the wireless communication unit 21 supports a plurality of radio access schemes, each unit of the wireless communication unit 21 can be configured individually for each radio access scheme. For example, the transmission processing unit 211 and the reception processing unit 212 may be individually configured by LTE and NR. Furthermore, the antenna 213 may include a plurality of antenna elements (for example, a plurality of patch antennas). In this case, the wireless communication unit 21 may be configured to be beamformable. The wireless communication unit 21 may be configured to be able to perform polarization beamforming using vertically polarized waves (V-polarized waves) and horizontally polarized waves (H-polarized waves).

The transmission processing unit 211 performs a process of transmitting the downlink control information and the downlink data. For example, the transmission processing unit 211 encodes the downlink control information and the downlink data input from the controller 23 using an encoding method such as block encoding, convolutional encoding, turbo encoding, or the like. Here, the encoding may be performed by polar code encoding or low density parity check code (LDPC code) encoding. Then, the transmission processing unit 211 modulates the coded bits by a predetermined modulation method such as BPSK, QPSK, 16-QAM, 64-QAM, or 256-QAM. In this case, the signal points on the constellation do not necessarily have to be equidistant. The constellation may be a non-uniform constellation (NUC). Then, the transmission processing unit 211 multiplexes the modulation symbol of each channel and the downlink reference signal and arranges the multiplexed symbols in a predetermined resource element. Then, the transmission processing unit 211 performs various types of signal processing on the multiplexed signal. For example, the transmission processing unit 211 performs processing such as conversion into a frequency domain by fast Fourier transform, addition of a guard interval (cyclic prefix), generation of a baseband digital signal, conversion into an analog signal, quadrature modulation, up-conversion, removal of an extra frequency component, and amplification of power. The signal generated by the transmission processing unit 211 is transmitted from the antenna 213.

The reception processing unit 212 processes the uplink signal received via the antenna 213. For example, the reception processing unit 212 performs down-conversion, removal of an unnecessary frequency component, control of an amplification level, quadrature demodulation, conversion to a digital signal, removal of a guard interval (cyclic prefix), extraction of a frequency domain signal by fast Fourier transform, and the like on the uplink signal. Then, the reception processing unit 212 separates an uplink channel such as a physical uplink shared channel (PUSCH) and a physical uplink control channel (PUCCH) and an uplink reference signal from the signals subjected to these processes. Further, the reception processing unit 212 demodulates the received signal using a modulation method such as binary phase shift keying (BPSK) or quadrature phase shift keying (QPSK) with respect to the modulation symbol of the uplink channel. The modulation method used for demodulation may be 16-quadrature amplitude modulation (QAM), 64-QAM, or 256-QAM. In this case, the signal points on the constellation do not necessarily have to be equidistant. The constellation may be a non-uniform constellation (NUC). Then, the reception processing unit 212 performs a decoding process on the demodulated encoded bits of the uplink channel. The decoded uplink data and uplink control information are output to the controller 23.

The antenna 213 is an antenna device (antenna unit) that mutually converts a current and a radio wave. The antenna 213 may include one antenna element (for example, one patch antenna) or may include a plurality of antenna elements (for example, a plurality of patch antennas). In a case where the antenna 213 includes a plurality of antenna elements, the wireless communication unit 21 may be configured to be beamformable. For example, the wireless communication unit 21 may be configured to generate a directional beam by controlling the directivity of a wireless signal using the plurality of antenna elements. Note that the antenna 213 may be a dual-polarized antenna. In a case where the antenna 213 is a dual-polarized antenna, the wireless communication unit 21 may use vertically polarized waves (V-polarized waves) and horizontally polarized waves (H-polarized waves) in transmitting wireless signals. Then, the wireless communication unit 21 may control the directivity of the wireless signal transmitted using the vertically polarized waves and the horizontally polarized waves. Furthermore, the wireless communication unit 21 may transmit and receive spatially multiplexed signals via a plurality of layers including a plurality of antenna elements.

The storage unit 22 is a data readable/writable storage device, such as a DRAM, an SRAM, a flash memory, or a hard disk. The storage unit 22 functions as a storage unit of the base station 20.

The controller 23 is a controller that controls each unit of the base station 20. The controller 23 is implemented by, for example, a processor such as a central processing unit (CPU), or a micro processing unit (MPU). For example, the controller 23 is implemented by a processor executing various programs stored in a storage device inside the base station 20 using a random access memory (RAM) or the like as a work area. Furthermore, the controller 23 may be implemented by, for example, an integrated circuit such as an application specific integrated circuit (ASIC) or a field programmable gate array (FPGA). Any of the CPU, the MPU, the ASIC, and the FPGA can be regarded as a controller. Furthermore, the controller 23 may be implemented by a graphics processing unit (GPU) in addition to or instead of the CPU.

In some embodiments, the concept of a base station may consist of a collection of multiple physical or logical devices.

For example, in this embodiment, the base station may be distinguished into a plurality of apparatuses such as a baseband unit (BBU) and a radio unit (RU). Then, the base station may be interpreted as an assembly of the plurality of apparatuses. In addition, the base station may be either or both of a BBU and an RU. The BBU and the RU may be connected by a predetermined interface (for example, an enhanced common public radio interface (eCPRI)). The RU may be referred to as a remote radio unit (RRU) or a radio dot (RD). Furthermore, the RU may support a gNB distributed unit (gNB-DU) described later. Further, the BBU may support a gNB central unit (gNB-CU) described later. Alternatively, the RU may be a wireless device connected to a gNB-DU described later. The gNB-CU, the gNB-DU, and the RU connected to the gNB-DU may be configured to conform to an open radio access network (O-RAN). Further, the RU may be an apparatus integrally formed with an antenna. An antenna (for example, an antenna integrally formed with an RU) included in the base station may adopt an advanced antenna system and support MIMO (for example, FD-MIMO) or beamforming. Furthermore, the antenna included in the base station may include, for example, 64 transmission antenna ports and 64 reception antenna ports.

In addition, the antenna mounted on the RU may be an antenna panel including one or more antenna elements, and the RU may be mounted with one or more antenna panels. For example, the RU may be mounted with two antenna panels of a horizontally polarized antenna panel and a vertically polarized antenna panel, or two antenna panels of a clockwise circularly polarized antenna panel and a counterclockwise circularly polarized antenna panel. In addition, the RU may form and control an independent beam for each antenna panel.

Note that a plurality of base stations may be connected to each other. The one or more base stations may be included in a radio access network (RAN). In this case, the base station may be simply referred to as a RAN, a RAN node, an access network (AN), or an AN node. Note that the RAN in LTE is sometimes referred to as an enhanced universal terrestrial RAN (EUTRAN). In addition, RAN in NR may be referred to as NGRAN. In addition, RAN in W-CDMA (UMTS) is sometimes referred to as UTRAN.

Note that an LTE base station may be referred to as an evolved node B (eNodeB) or an eNB. At this time, the EUTRAN includes one or more units of eNodeB (eNB). Further, an NR base station may be referred to as a gNodeB or a gNB. At this time, the NGRAN includes one or more units of gNB. The EUTRAN may include a gNB (en-gNB) connected to a core network (EPC) in an LTE communication system (EPS). Similarly, the NGRAN may include an ng-eNB connected to a core network 5GC in a 5G communications system (5GS).

When the base station is an eNB, a gNB, or the like, the base station may be referred to as 3GPP access. In addition, when the base station is a wireless access point, the base station may be referred to as non-3GPP access. Furthermore, the base station may be an optical remote device called a remote radio head (RRH) or a radio unit (RU). Furthermore, in a case where the base station is a gNB, the base station may be a combination of the qNB-CU and the gNB-DU described above, or may be any one of the gNB-CU and the gNB-DU.

Here, the gNB-CU hosts a plurality of upper layers (for example, radio resource control (RRC), service data adaptation protocol (SDAP), and packet data convergence protocol (PDCP)) in an access stratum for communication with the UE. On the other hand, the gNB-DU hosts a plurality of lower layers (for example, radio link control (RLC), medium access control (MAC), and physical layer (PHY)) in an access stratum. That is, among messages/information to be described later, RRC signaling (semi-static notification) may be generated by the gNB-CU, while MAC CE and DCI (dynamic notification) may be generated by the qNB-DU. Alternatively, in the RRC configuration (semi-static notification), for example, some configurations such as IE: cellGroupConfig may be generated by the gNB-DU, and the remaining configurations may be generated by the gNB-CU. These configurations may be transmitted and received through an F1 interface described later.

Note that the base station may be configured to be able to communicate with another base station. For example, when a plurality of base stations is an eNB and an eNB or a combination of an eNB and an en-gNB, the base stations may be connected by an X2 interface. Furthermore, when a plurality of base stations is a gNB and a gNB or a combination of a gn-eNB and a gNB, the devices may be connected by an Xn interface. Furthermore, when a plurality of base stations is a combination of a gNB-CU and a gNB-DU, the devices may be connected by the F1 interface described above. A message/information (for example, RRC signaling, MAC control element (MAC CE), or DCI) to be described later may be transmitted between a plurality of base stations, for example, via an X2 interface, an Xn interface, or an F1 interface.

A cell provided by the base station may be referred to as a serving cell. The concept of a serving cell includes a primary cell (PCell) and a secondary cell (SCell). When dual connectivity is configured for the UE (for example, the terminal device 30), the PCell provided by the master node (MN) and zero or one or more SCells may be referred to as a master cell group. Examples of dual connectivity include EUTRA-EUTRA Dual Connectivity, EUTRA-NR Dual Connectivity (ENDC), EUTRA-NR Dual Connectivity with 5GC, NR-EUTRA Dual Connectivity (NEDC), and NR-NR Dual Connectivity.

The serving cell may include a PSCell (Primary Secondary Cell or Primary SCG Cell). When dual connectivity is configured for the UE, the PSCell provided by the secondary node (SN) and zero or one or more SCells may be referred to as secondary cell group (SCG). Unless specially configured (for example, PUCCH on SCell), the physical uplink control channel (PUCCH) is transmitted in the PCell and the PSCell, but is not transmitted in the SCell. In addition, a radio link failure is also detected in the PCell and the PSCell, but is not detected in the SCell (not need to be detected). As described above, since the PCell and the PSCell have a special role in the serving cell, they are also referred to as special cell (SpCell).

One downlink component carrier and one uplink component carrier may be associated with one cell. In addition, the system bandwidth corresponding to one cell may be divided into a plurality of bandwidth parts (BWPs). In this case, one or more BWPs may be configured for the UE, and one BWP may be used for the UE as an active BWP. Furthermore, radio resources (for example, a frequency band, a numerology (subcarrier spacing), and a slot format (slot configuration)) that can be used by the terminal device 30 may be different for each cell, each component carrier, or each BWP.

### 2-4. Configuration of Terminal Device

Next, a configuration of the terminal device 30 will be described. The terminal device 30 can be rephrased as the user equipment (UE) 30.

The terminal device 30 is a wireless communication device that wirelessly communicates with other communication devices such as the base station 20. The terminal device 30 is, for example, a mobile phone, a smart device (smartphone or tablet), a personal digital assistant (PDA), or a personal computer. Furthermore, the terminal device 30 may be a device such as a business camera provided with a communication function, or may be a motorcycle, a moving relay vehicle, or the like on which a communication device such as a field pickup unit (FPU) is mounted. Furthermore, the terminal device 30 may be a machine to machine (M2M) device or an internet of things (Iot) device.

Note that the terminal device 30 may be able to perform NOMA communication with the base station 20. Furthermore, the terminal device 30 may be able to use an automatic retransmission technology such as HARQ when communicating with the base station 20. The terminal device 30 may be capable of sidelink communication with another terminal device 30. The terminal device 30 may also be able to use an automatic retransmission technology such as HARQ when performing sidelink communication. Note that the terminal device 30 may also be capable of NOMA communication in communication (sidelink) with other terminal devices 30. Furthermore, the terminal device 30 may be able to perform LPWA communication with another communication devices (for example, the base station 20 and another terminal device 30). Furthermore, the wireless communication used by the terminal device 30 may be wireless communication using millimeter waves. Note that the wireless communication (including sidelink communication) used by the terminal device 30 may be wireless communication using radio waves or wireless communication using infrared rays or visible light (optical wireless).

Furthermore, the terminal device 30 may be a mobile device. The mobile device is a mobile wireless communication device. At this time, the terminal device 30 may be a wireless communication device installed in a mobile body or may be a mobile body itself. For example, the terminal device 30 may be a vehicle that moves on a road such as an automobile, a bus, a truck, or a motorcycle, a vehicle that moves on a rail installed on a track such as a train, or a wireless communication device mounted on the vehicle. Note that the mobile body may be a mobile terminal, or may be a mobile body that moves on land (on the ground in a narrow sense), in the ground, on the water, or under the water. Furthermore, the mobile body may be a mobile body that moves inside the atmosphere, such as a drone or a helicopter, or may be a mobile body that moves outside the atmosphere, such as an artificial satellite.

The terminal device 30 may be simultaneously connected to a plurality of base stations or a plurality of cells to perform communication. For example, in a case where one base station supports a communication area via a plurality of cells (for example, pCell, sCell), the plurality of cells can be bundled and communicated between the base station 20 and the terminal device 30 by a carrier aggregation (CA) technology, a dual connectivity (DC) technology, or a multi-connectivity (MC) technology. Alternatively, the terminal device 30 and the plurality of base stations 20 can communicate with each other by a coordinated multi-point transmission and reception (COMP) technology via cells of different base stations 20.

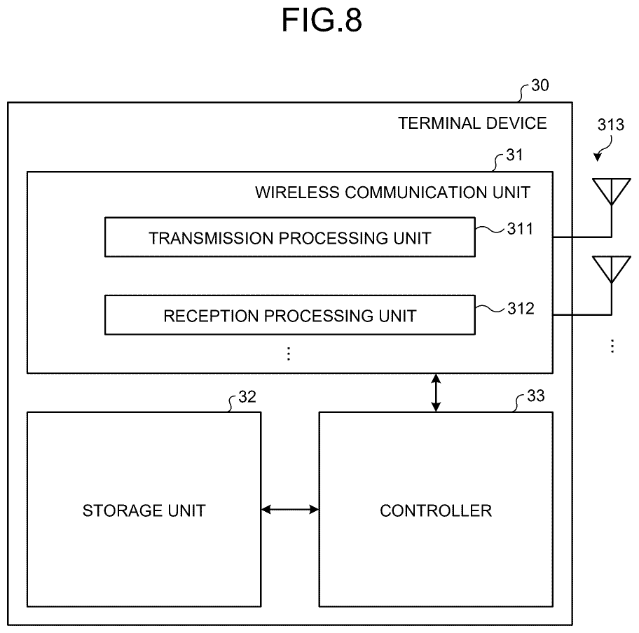

FIG. 8 is a diagram illustrating a configuration example of the terminal device 30 according to the embodiment of the present disclosure. The terminal device 30 includes a wireless communication unit 31, a storage unit 32, and a controller 33. Note that the configuration illustrated in FIG. 8 is a functional configuration, and the hardware configuration may be different from this functional configuration. Furthermore, the functions of the terminal device 30 may be implemented in a distributed manner in a plurality of physically separated configurations.

The wireless communication unit 31 is a signal processing unit for wirelessly communicating with other wireless communication devices (for example, the base station 20 and another terminal device 30). The wireless communication unit 31 operates under the control of the controller 33. The wireless communication unit 31 includes a transmission processing unit 311, a reception processing unit 312, and an antenna 313. The configurations of the wireless communication unit 31, the transmission processing unit 311, the reception processing unit 312, and the antenna 313 may be similar to those of the wireless communication unit 21, the transmission processing unit 211, the reception processing unit 212, and the antenna 213 of the base station 20. Further, the wireless communication unit 31 may be configured to be beamformable similarly to the wireless communication unit 21. Further, similarly to the wireless communication unit 21, the wireless communication unit 31 may be configured to be able to transmit and receive spatially multiplexed signals.

The storage unit 32 is a data readable/writable storage device, such as a DRAM, an SRAM, a flash memory, or a hard disk. The storage unit 32 functions as a storage unit of the terminal device 30.

The controller 33 is a controller that controls each unit of the terminal device 30. The controller 33 is implemented by, for example, a processor such as a CPU or an MPU. For example, the controller 33 is implemented by a processor executing various programs stored in a storage device inside the terminal device 30 using a RAM or the like as a work area. Note that the controller 33 may be implemented by an integrated circuit such as an ASIC or an FPGA. Any of the CPU, the MPU, the ASIC, and the FPGA can be regarded as a controller. Furthermore, the controller 33 may be implemented by a GPU in addition to or instead of the CPU.

### 2-5. Configuration of Network Management Device

Next, a configuration of the network management device 40 will be described.

The network management device 40 is an information processing apparatus (computer) including private network association management (PNAM) which is a management function for managing the plurality of private networks. For example, the network management device 40 is a central management server installed by an administrator who manages a private network.

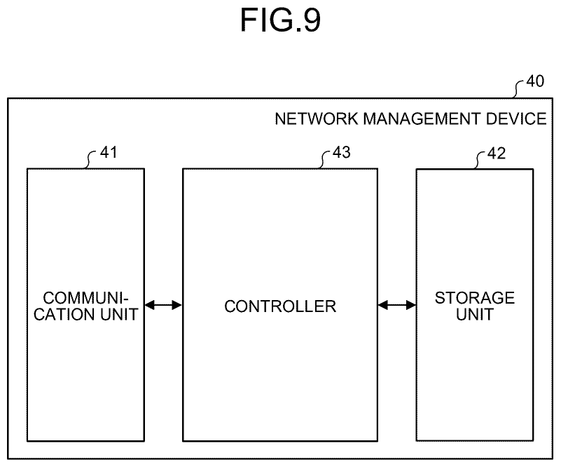

FIG. 9 is a diagram illustrating a configuration example of the network management device 40 according to the embodiment of the present disclosure. The network management device 40 includes a communication unit 41, a storage unit 42, and a controller 43. Note that the configuration illustrated in FIG. 9 is a functional configuration, and the hardware configuration may be different from this functional configuration. Furthermore, the functions of the network management device 40 may be implemented in a statically or dynamically distributed manner in a plurality of physically separated configurations. For example, the network management device 40 may include a plurality of server devices.

The communication unit 41 is a communication interface for communicating with other devices. The communication unit 41 may be a network interface or a device connection interface. For example, the communication unit 41 may be a local area network (LAN) interface such as a network interface card (NIC), or may be a USB interface including a universal serial bus (USB) host controller, a USB port, and the like. Further, the communication unit 41 may be a wired interface or a wireless interface. The communication unit 41 functions as a communication unit of the network management device 40. The communication unit 41 communicates with the management device 10 and the like under the control of the controller 43.

The storage unit 42 is a data readable/writable storage device such as a dynamic random access memory (DRAM), a static random access memory (SRAM), a flash memory, or a hard disk. The storage unit 42 functions as a storage unit of the network management device 40.

The controller 43 is a controller that controls each unit of the network management device 40. The controller 43 is implemented by, for example, a processor such as a central processing unit (CPU), a micro processing unit (MPU), or a graphics processing unit (GPU). For example, the controller 43 is implemented by a processor executing various programs stored in a storage device inside the network management device 40 using a random access memory (RAM) or the like as a work area. Furthermore, the controller 43 may be implemented by, for example, an integrated circuit such as an application specific integrated circuit (ASIC) or a field programmable gate array (FPGA). Any of the CPU, the MPU, the GPU, the ASIC, and the FPGA can be regarded as a controller.

### 3. Network Architecture

The configuration of the communication system 1 has been described above. Next, a network architecture applicable to the communication system 1 of the present embodiment will be described.

### 3-1. Configuration Example of 5G Network Architecture

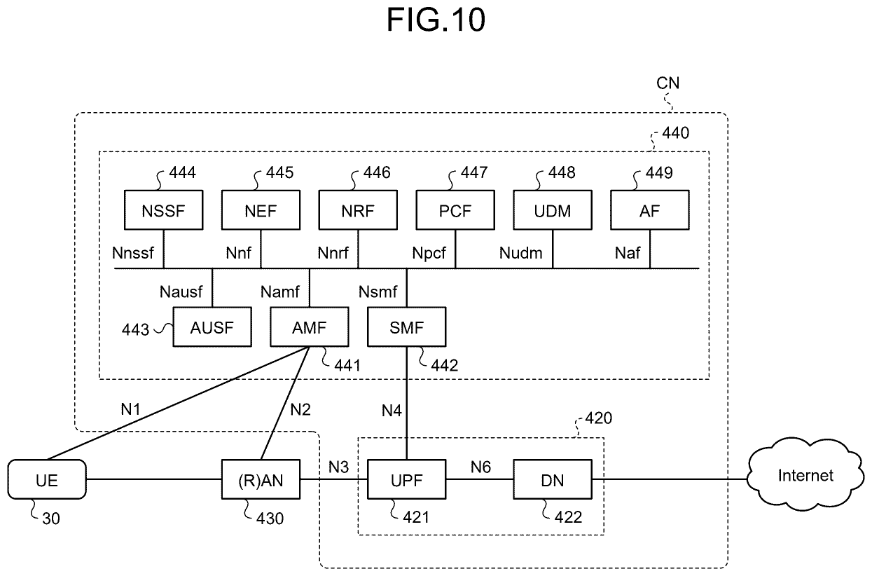

First, an architecture of the fifth generation mobile communication system (5G) will be described as an example of a core network CN of the communication system 1. FIG. 10 is a diagram illustrating an example of 5G architecture. The 5G core network CN is also referred to as 5G core (5GC)/next generation core (NGC). Hereinafter, the 5G core network CN is also referred to as 5GC/NGC. The core network CN is connected to the user equipment (UE) 30 via a (R)AN 430. The UE 30 is, for example, the terminal device 30. Note that the core network CN illustrated in FIG. 10 does not include private network association management (PNAM) which is a management function for managing a plurality of private networks, but the core network CN may include a PNAM as one of the network functions. Needless to say, the PNAM may be a network function located outside the core network CN.

The (R)AN 430 has a function of enabling connection to a radio access network (RAN) and connection to an access network (AN) other than the RAN. The (R)AN 430 includes a base station called a gNB or an ng-eNB.

The core network CN mainly performs connection acceptance and session management when the UE 30 is connected to the network. The core network CN may include a user plane function group 420 and a control plane function group 440.

The user plane function group 420 includes a user plane function (UPF) 421 and a data network (DN) 422. The UPF 421 has a function of user plane processing. The UPF 421 includes a routing/forwarding function of data handled in a user plane. The DN 422 has a function of providing an entity, such as a mobile network operator (MNO), which provides a connection to an operator's own service, providing an Internet connection, or providing a connection to a third party service. As described above, the user plane function group 420 plays a role of a gateway serving as a boundary between the core network CN and the Internet.

The control plane function group 440 includes an access management function (AMF) 441, a session management function (SMF) 442, an authentication server function (AUSF) 443, a network slice selection function (NSSF) 444, a network exposure function (NEF) 445, a network repository function (NRF) 446, a policy control function (PCF) 447, a unified data management (UDM) 448, and an application function (AF) 449.

The AMF 441 has functions such as registration processing, connection management, and mobility management of the UE 30. The SMF 442 has functions such as session management and IP assignment and management of the UE 30. The AUSF 443 has an authentication function. The NSSF 444 has a function related to selection of a network slice. The NEF 445 has a function of providing network function capabilities and events to a third party, the AF 449, and edge computing functions.

The NRF 446 has a function of finding a network function and holding a profile of the network function. The PCF 447 has a function of policy control. The UDM 448 has functions of generating 3GPP AKA authentication information and processing a user ID. The AF 449 has a function of interacting with the core network to provide a service.

For example, the control plane function group 440 acquires information from the UDM 448 in which subscriber information of the UE 30 is stored, and determines whether or not the UE 30 may connect to the network. The control plane function group 440 uses the contract information of the UE 30 included in the information acquired from the UDM 448 and a key for encryption for such determination. In addition, the control plane function group 440 generates the key for encryption and the like.

That is, the control plane function group 440 determines whether or not the network can be connected according to whether or not information of the UE 30 associated with a subscriber number called international mobile subscriber identity (IMSI) is stored in the UDM 448, for example. Note that the IMSI is stored in, for example, a subscriber identity module (SIM) card in the UE 30.

Here, Namf is a service-based interface provided by the AMF 441, and Nsmf is a service-based interface provided by the SMF 442. In addition, Nnef is a service-based interface provided by the NEF 445, and Npcf is a service-based interface provided by the PCF 447. Nudm is a service-based interface provided by the UDM 448, and Naf is a service-based interface provided by the AF 449. Nnrf is a service-based interface provided by the NRF 446, and Nnssf is a service-based interface provided by the NSSF 444. Nausf is a service-based interface provided by the AUSF 443. Each of these network functions (NFs) exchanges information with another NF via each service-based interface.

In addition, N1 illustrated in FIG. 10 is a reference point between the UE 30 and the AMF 441, and N2 is a reference point between the RAN/AN 430 and the AMF 441. N4 is a reference point between the SMF 442 and the UPF 421, and information is exchanged between these network functions (NFs).

As described above, in the core network CN, an interface for transmitting information and controlling functions via an application programming interface (API) called a service-based interface is prepared.

The API specifies a resource and enables GET (acquisition of resource), POST (creation of resource and addition of data), PUT (creation of resource, updating resource), DELETE (deletion of resource), and the like for the resource. Such functions are generally used, for example, in the technical field related to the Web.

For example, the AMF 441, the SMF 442, and the UDM 448 illustrated in FIG. 10 exchange information with each other using the API in a case of establishing a communication session. Conventionally, it is not assumed that an application (for example, AF 449) uses such an API. However, when AF 449 uses such an API, AF 449 can use information of a 5G cellular network, and it is considered that a function of an application can be further evolved.

Note that it is difficult for the AF 289 to use the API used by the AMF 441, the SMF 442, and the UDM 448 in the public network. However, in the case of a non-public private 5G network, it is considered that the system can be configured including, for example, a change in the API of the core network CN so that the AF 289 can use such an API.

Here, an example of the API will be described. The API(1) to API(4) described here are described in 3GPP TS23.502.

### API(1)

The API(1) is an API notified by the SMF 442 indicating the fact that the UE 30 registered in advance transitions from the power off state to the power on state and attaches to the network, and the IP address acquired at that time.

The SMF 442 uses the API(1) to notify the NF when the UE 30 of the registered IMSI obtains the IP address.

### API(2)

The UE 30 enters the Idle mode when not communicating, and transitions to a connected mode when communicating. The API(2) is an API notified by the AMF 441 indicating whether the UE 30 is in the Idle mode or the connected mode.

### API(3)

The API(3) is an API for broadcasting a message (paging message) for instructing the UE 30 to transition from the Idle mode to the connected mode from the base station.

### API(4)

The API(4) is an API in which the AMF 441 provides the location information of the UE 30. The AMF 441 may use the API(4) to announce which tracking area the UE 30 is in, which cell it belongs to, and when it enters a specific region.

Note that an example of the UE 30 in FIG. 10 is the terminal device 30 of the present embodiment. An example of the RAN/AN 430 is the base station 20 of the present embodiment. Furthermore, the management device 10 illustrated in FIG. 5 is an example of a device having a function of, for example, the AF 449 or the AMF 441.

### 3-2. Configuration Example of 4G Network Architecture

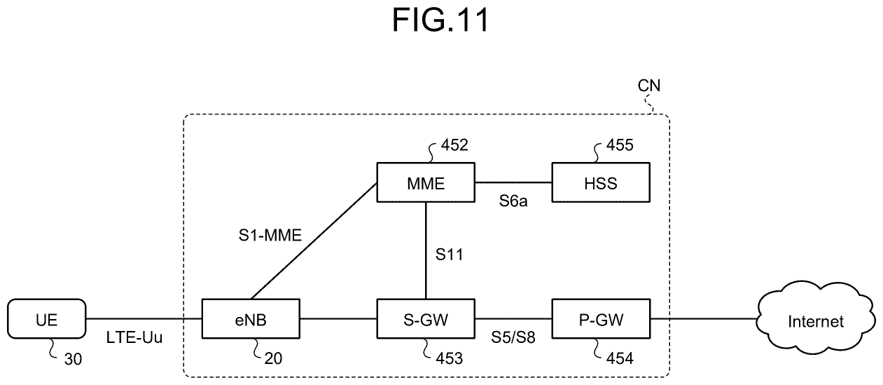

Next, with reference to FIG. 11, an architecture of the fourth generation mobile communication system (4G) will be described as an example of the core network CN of the communication system 1. FIG. 11 is a diagram illustrating an example of 4G architecture. Note that the core network CN illustrated in FIG. 11 does not include private network association management (PNAM) which is a management function for managing a plurality of private networks, but the core network CN may include a PNAM as one of the network functions. Needless to say, the PNAM may be a network function located outside the core network CN.

As illustrated in FIG. 11, the core network CN includes an eNB 20, a mobility management entity (MME) 452, a serving gateway (S-GW) 453, a packet data network gateway (P-GW) 454, and a home subscriber server (HSS) 455.

The eNB 20 functions as a 4G base station. The MME 452 is a control node that handles signals of a control plane and manages a movement state of UE 401. The UE 401 sends an attach request to the MME 452 to attach to the cellular system.

The S-GW 453 is a control node that handles user plane signals, and is a gateway device that switches a transfer path of user data. The P-GW 454 is a control node that handles user plane signals and is a gateway device serving as a connection point between the core network CN and the Internet. The HSS 455 is a control node that handles subscriber data and performs service control.

The MME 452 corresponds to the functions of the AMF 441 and the SMF 442 in the 5G network. In addition, the HSS 455 corresponds to the function of the UDM 448.

As illustrated in FIG. 11, the eNB 20 is connected to the MME 452 via the S1-MME interface, and is connected to the S-GW 453 via the S1-U interface. The S-GW 453 is connected to the MME 452 via the S11 interface, and the MME 452 is connected to the HSS 455 via the S6a interface. The P-GW 454 is connected to the S-GW 453 via an S5/S8 interface.

### 4. First Embodiment

The configuration of the communication system 1 has been described above. Next, the operation of the communication system 1 having such a configuration will be described.

### 4-1. Problem

When a plurality of independent private networks is connected by communication, it is important to ensure security. Normally, since the private network operates as a closed network, security is secured. However, when the private network is connected to other private networks, the possibility of network attack from the malicious UE/AF in other private networks increases. As the network attack, a denial-of-service attack (Dos) attack in which a large number of packets are sent, an attack in which a virus or the like is sent, and the like are assumed.

In any attack, a problem occurs with the arrival of a packet from a malicious user as a starting point. Therefore, when a plurality of private networks are connected, a mechanism resistant to an attack from a malicious user of another private network is required. Basically, a mechanism in which a packet from a malicious user does not arrive is required, but for this purpose, it is necessary to consider how to accept connection to a plurality of private networks.

Therefore, in the first embodiment, a plurality of private network connection procedures is considered in order to create a secure system.

### 4-2. First Solution

Reducing unnecessary connections as much as possible leads to improved security. Therefore, first, it is considered who mainly issues the connection request. The basic idea is that a user designates a user and issues a connection request. At this time, even if a user B wants to connect to a user A, accepting the connection even when the user A does not want to connect to the user B increases a security threat. Therefore, a mechanism for mutually accepting connection is required.

In the present embodiment, a network management device 40 that manages closed network communication of a plurality of private networks connected by a VPN tunnel is prepared. The network management device 40 has a management function for managing closed network communication of a plurality of private networks connected by a VPN tunnel. In the following description, this management function is referred to as private network association management (PNAM). In response to the connection request from the user B to the user A, the PNAM asks the user A whether to accept the connection request from the user B. In a case where the response of agreeing to the connection with the user A is received from the user B, the PNAM recognizes that it is necessary to connect the private network A to which the user A belongs and the private network B to which the user B belongs. Note that this agreement information may be held as connection acceptance information of the user A in a database (for example, the storage unit 42 of the network management device 40) of the PNAM in advance.

Table 1 is a table illustrating an example of a database storing information indicating to which node connection is accepted for each node (hereinafter, the information is referred to as the first connection acceptance information). More specifically, Table 1 is a table showing a database in which information on other nodes to which connection with a predetermined node is accepted is recorded. The node may be UE or AF. In the example of Table 1, connection acceptance information indicating that the node accepted to connect to the UE A is the UE B and connection acceptance information indicating that the node accepted to connect to the UE B is the UE A are recorded in the database.

TABLE 1

| | User accepted to |
|---|---|
| | connect even if located |
| | on other networks |
| UE X | |
| UE A | UE B |
| UE B | UE A |
| UE X | |

The PNAM makes a final decision on whether to actually connect the private network A and the private network B. At this time, the PNAM may determine that the connection is actually established when ten sets of connection requests are accumulated. It may be automatic, or an administrator may determine and transmit a command to connect two private networks using the GUI.

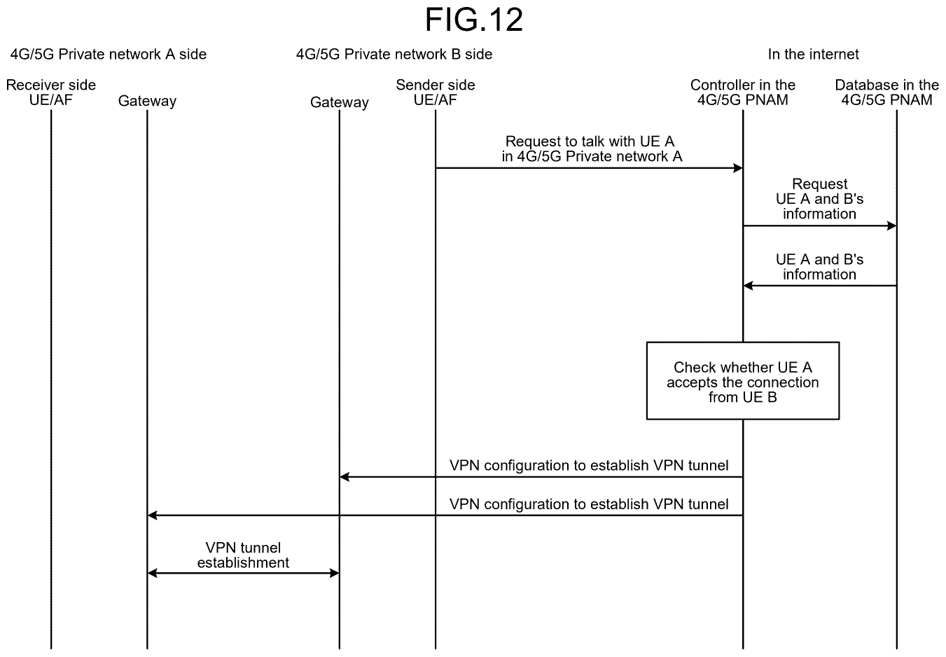

FIG. 12 is a sequence diagram illustrating a connection procedure of two private networks. FIG. 12 illustrates a connection sequence between a node (UE/AF) belonging to the private network A and a node (UE/AF) belonging to the private network B. In each of the two private networks, a gateway that performs an operation related to restriction of closed network communication based on a notification from the PNAM is disposed. The operation related to restriction of closed network communication is, for example, IP filtering. By the PNAM, the gateway of at least one of the two private networks in which the closed network communication is performed is notified of restriction of the closed network communication.

Note that, in the following description, the UE is, for example, the terminal device 30, the gateway is, for example, the management device 10, and the PNAM is, for example, the network management device 40. Hereinafter, a connection procedure of two private networks will be described with reference to FIG. 12.

First, the node (UE/AF) that belongs to the private network B sends information of an access request to the node (UE/AF) that belongs to the private network A to a controller (for example, the controller 43 of the network management device 40) of the PNAM. The controller of the PNAM obtains information of the access request from the node that belongs to the private network B to the node (UE/AF) that belongs to the private network A. In the following description, it is assumed that the controller of the PNAM obtains the information of the access request to the UE A that belongs to the private network A from the UE B that belongs to the private network B.

The controller of the PNAM determines whether or not to accept access from the UE B to the UE according to a predetermined criterion. This processing is performed by, for example, the following procedure. First, a controller of the PNAM obtains connection acceptance information of UE A and UE B from a database (for example, the storage unit 42 of the network management device 40) of the PNAM. In the example of Table 1 described above, the connection acceptance information of the UE A is information that the connection with the UE B is accepted, and the connection acceptance information of the UE B is information that the connection with the UE A is accepted. Then, the controller of the PNAM determines whether or not to accept access from the UE B to the UE based on the connection acceptance information of the UE A and the UE B. In the example of Table 1, because both UE A and UE B are accepted to connect to the other, the controller of the PNAM makes a decision to accept UE B to access the UE.

The controller of the PNAM then notifies the gateway of at least one of the two private networks of the foregoing decision. In the example of FIG. 12, the controller of the PNAM notifies both the gateway of private network A and the gateway of private network B of the foregoing decision.

When notified that the connection is accepted, the two gateways establish a VPN tunnel between the private network A and the private network B. Then, each of the two gateways performs an operation related to restriction of closed network communication, such as IP filtering.

This can reduce unnecessary connections, thereby reducing security threats. Because of the form of mutual authentication, a security threat can be reduced because a connection from a party to which the user does not want to connect can be rejected.

Note that, in the example of Table 1, the PNAM holds connection acceptance information of users (nodes) in a database. However, the PNAM may hold the connection acceptance information between the private networks in the database. In this case, even if the access requests of the UE A and the UE B are valid, the prohibited private network cannot be connected. Table 2 is a table illustrating an example of a database storing information indicating to which private network connection is accepted for each private network (hereinafter, the information is referred to as the second connection acceptance information). More specifically, Table 2 is a table showing a database in which information of other private networks to which connection with a predetermined private network is accepted is recorded.

TABLE 2

| Private | Other network |
|---|---|
| network | accepted to connect |
| A | B |
| B | A |
| C | |
| D | |

In the example of Table 2, the private network A and the private network B can be connected, but cannot be connected otherwise. That is, for the example in Table 2, the private network A and the private network C cannot be connected, and the private network A and the private network D cannot be connected. In addition, the private network B and the private network C cannot be connected, and the private network B and the private network D cannot be connected. The private network C and the private network D cannot be connected. The PNAM may determine, by using both the first connection acceptance information and the second connection acceptance information, whether or not to accept access from a node that belongs to the private network B to a node that belongs to the private network A.

It is assumed that the UE A and the UE B may want to accept the closed network communication only when using the private network A and the private network B. Therefore, the PNAM may hold, in a database, combination information of a node accepted to connect to a predetermined node and a closed network. Table 3 is a table illustrating an example of a database storing information indicating to which node of which private network is accepted to connect (hereinafter, the information is referred to as the third connection acceptance information) for each node.

TABLE 3

| | User accepted to connect even if |
|---|---|
| | located on other networks |
| UE X | |
| UE A | UE B of private network B |
| UE B | UE A of private network A |
| UE X | |

In the example of Table 3, connection acceptance information indicating that the node accepted to connect to the UE A is the UE B of the private network B and connection acceptance information indicating that the node accepted to connect to the UE B is the UE A of the private network A are recorded in the database. The PNAM may determine, by using both pieces of the third connection acceptance information, whether or not to accept access from the node B that belongs to the private network B to the node A that belongs to the private network A.

### 4-3. Second Solution

If the connection between the plurality of private networks that does not need to communicate is left as it is, an unnecessary security threat increases. When it is no longer necessary, it is desirable to disconnect the connection, but what triggers the disconnection becomes a problem. As disconnection methods, the following (1) to (3) are assumed.
(1) Once there is no communication between nodes communicating across the private network, the PNAM determines a disconnect at some later time.
(2) After connection between the private networks for a certain period of time, disconnection is performed. A certain period, for example, one day, three hours, or the like is determined in advance. Even in a case where it is desired to continuously use the connection, the connection is once disconnected, the node requests for connection again, and then the PNAM determines whether or not to connect again.
(3) A notification from the node that it no longer needs to continue the connection is provided. When communication across the private networks is no longer necessary, the node notifies the PNAM of the fact. When there is a notification that it is not necessary to continue the connection from all the nodes communicating across the connections in the connected private network (hereinafter, the notification is referred to as a communication termination notification), the PNAM determines to disconnect the connection.
Among the above (1) to (3), the best method is considered to be the method (3). This is because it is clear that communication is obviously not required and disconnection may be performed. Other methods may be used depending on the case.

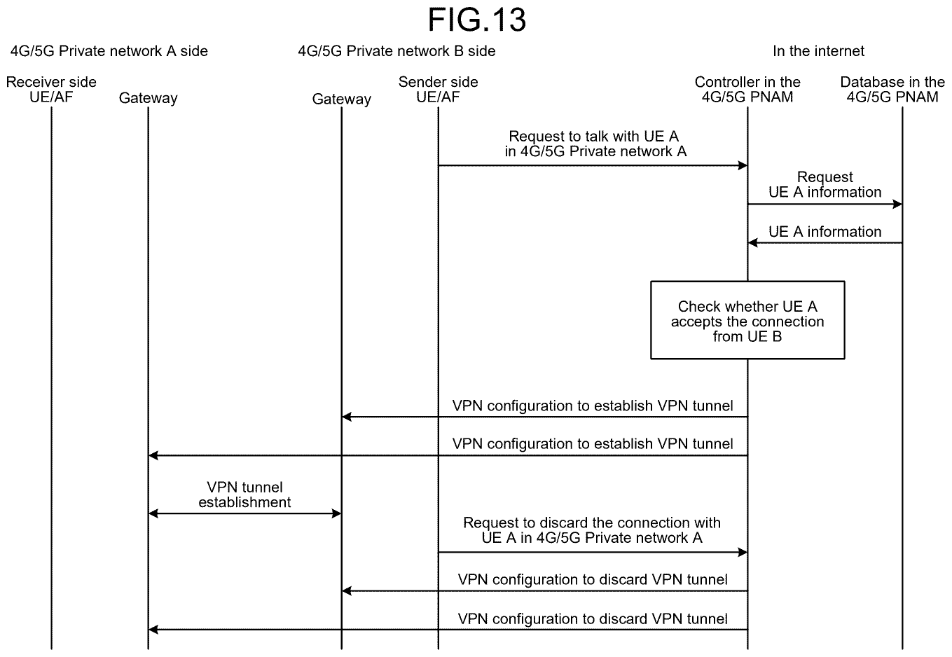

FIG. 13 is a sequence diagram illustrating a procedure of connection and disconnection of two private networks. After the private network A and the private network B are connected, the controller of the PNAM disconnects the connection between the private network A and the private network B when a predetermined condition is satisfied.

FIG. 13 illustrates a procedure for realizing the disconnecting method of (3) among the above three methods. In the first half, a procedure similar to the connection procedure illustrated in FIG. 12 is illustrated. The latter part illustrates a procedure in which the connection of the two private networks is disconnected based on a request from a node (UE/AF) of the private network B. Hereinafter, the disconnection procedure will be described with reference to the sequence diagram of FIG. 13. Note that the first half is similar to the connection procedure illustrated in FIG. 12, and thus description thereof is omitted.

When receiving a request to disconnect the connection to the UE A of the private network A from the node (UE/AF) of the private network B, the controller of the PNAM determines whether or not to disconnect the connection between the private network A and the private network B. For example, the controller of the PNAM determines to disconnect the connection when receiving the communication termination notification from all the nodes communicating between the private network A and the private network B. When determining to disconnect the connection, the controller of the PNAM performs processing for disconnecting the connection between the private network A and the private network B.

The controller of the PNAM then notifies the gateway of at least one of the two private networks of the foregoing determination. In the example of FIG. 12, the controller of the PNAM notifies both the gateway of private network A and the gateway of private network B of the foregoing determination. The two gateways terminate the VPN tunnel between the private network A and the private network B when being notified of disconnecting.

This can reduce unnecessary connections, thereby reducing security threats.

Note that, in the procedure of FIG. 13, the controller of the PNAM disconnects the connection between the private network A and the private network B when receiving a notification of termination of all communication across the private network A and the private network B. However, the controller of the PNAM may disconnect the connection between the private network A and the private network B when a certain period of time has passed since there has been no communication across the private network A and the private network B.

In addition, the controller of the PNAM may disconnect the connection between the private network A and the private network B after a certain period of time has passed after connecting the private network A and the private network B, regardless of the presence or absence of communication across the private network A and the private network B.

### 5. Second Embodiment

Next, an operation of a communication system 1 of the second embodiment will be described.

### 5-1. Problem

After connecting a plurality of private networks, users other than the user who wishes to communicate can send the IP packets to another private network. For example, when the private network A and the private network B are connected, all users of the private network A and all users of the private network B can communicate with each other. Therefore, if there is a malicious user therein, a security problem occurs. For example, it is possible to easily perform an action such as sending a large amount of packets to increase the load of the network.

In the first embodiment, a plurality of private networks are connected so as to be able to communicate for a user who desires communication. The second embodiment provides a mechanism for allowing only accepted users to transmit packets to other private networks after connection. This further reduces security threats.

Here, a description will be given of a part in which a packet can be transmitted to another private network. Usually, when UE transmits a packet outside a closed network, a return packet is accepted to enter the closed network. For example, if UE in a private network accesses a website on the Internet outside of the private network, an IP packet carrying the return content (for example, the web page) can enter the private network even from outside of the private network.

A problem is a packet that directly enters the closed network from the outside other than the return packet. Sending a packet that is not the return packet from the private network B to the private network A is a security threat for the private network A. Therefore, a mechanism is necessary for determining whether an incoming packet from the outside is an allowable incoming packet. As means for solving such a problem, MAC address filtering and IP filtering are prepared.

The MAC address can be rewritten with an ID unique to the device. Therefore, MAC address filtering is weak as a security measure. On the other hand, it is difficult to rewrite the source IP address. This is because, even if a packet is transmitted by falsifying the source IP address, a router on the way to the destination clearly notices that the falsified source IP address is not appropriate. Therefore, IP filtering has been widely used as a security measure.

IP filtering is a function of discarding an IP packet other than a preset source IP address at the entry point of the private network. Such a function is set in the security GW at the entry point of the closed network. How to set this IP filtering when a plurality of private networks are communicably connected is a point of the present embodiment.

Here, one major problem is that the IP address of the UE of the user changes frequently. For example, when the UE performs a detach/attach to the network, a newer IP address than the core network is assigned. In a case where the core network is a 5G core, a session management network function (SMNF) assigns a new IP address to the UE. In a case where the core network is a 4G core, the PGW assigns a new IP address to the UE.

As a case where the UE detaches/attaches, for example, a case where WiFi is used from 5G and the UE returns to 5G again is assumed. If the UE is an IoT device, the UE may detach from the network once to in order to save battery of the IoT device, and attach again when needed.

It is ideal that filtering is performed with a UE-specific IP address. However, since the IP address of the UE changes frequently, it is difficult to perform filtering with the UE-specific IP address. Although it is possible to perform IP filtering in a wide range of IP addresses to some extent, one of the IP address may be allocated to a user who does not want to enter. Therefore, when IP filtering is performed with a wide range of IP addresses, a security threat remains.

### 5-2. First Solution

A plurality of IP address pools is assigned to the private network of the present embodiment. The plurality of IP address pools includes at least one IP address pool for closed network communication. Based on the notification from the PNAM, the gateway of the private network performs IP filtering for each unit of assigning the IP address (that is, for each IP address range associated with the IP address pool).

More specifically, the private network includes a plurality of user plane functions (UPFs) in which different IP address pools are set. A part of the plurality of UPFs (hereinafter, referred to as the first UPF) is a UPF prepared for a node (for example, UE) using the first UPF to perform closed network communication. Another UPF (hereinafter, referred to as the second UPF) among the plurality of UPFs is a UPF prepared for a node using the second UPF to perform closed network communication. The PNAM sends a notification to the gateway of the private network so as to perform IP filtering based on information of an IP address range associated with an IP address pool used for closed network communication (that is, the IP address pool set for the first UPF). Based on the notification from the PNAM, the gateway of the private network performs IP filtering for each unit to which an IP address is assigned (that is, for each UPF).

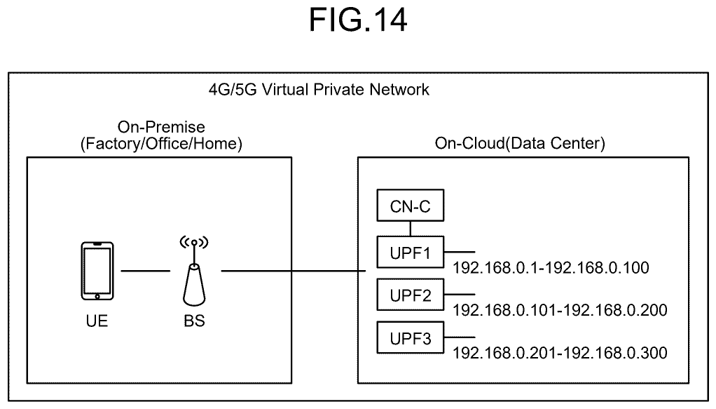

FIG. 14 is a diagram for explaining solutions of the second embodiment. In the case of 4G, the P-GW extracts one IP address from the pool of IP addresses and gives an IP address to the UE. In the 4G, the S-GW 453 and the P-GW 454 illustrated in FIG. 11 are a user plane, and the MME 452 is a control plane. In the following description, a set of an S-GW and a P-GW is referred to as a user plane function (UPF). For 5G, the UPF is the UPF 421.

The private network has a plurality of UPFs. In the example of FIG. 14, the private network includes a UPF 1, a UPF 2, and a UPF 3. By having the plurality of UPFs, it is possible to scale the processing capability of the UPF. A small number of UEs may be assigned to a specific UPF, and a large number of users may be assigned to other UPFs. As a result, the UPF to which a small number of users are assigned can also perform processing of providing high-quality communication.

Different IP address pools are set for the plurality of UPFs. The address range associated with the IP address pool set for each UPF is, for example, as follows:
UPF1: 192.168.0.1-192.168.0.100
UPF2: 192.168.0.101-192.168.0.200
UPF3: 192.168.0.201-192.168.0.300

At this time, when a certain UE attaches to the UPF 1, the UPF 1 gives 192.168.0.1 to the UE. Thereafter, when another UE attaches to the UPF 1, the UPF 1 gives 192.168.0.2 to the UE. In this manner, the UPF sequentially extracts the IP address from the IP address pool and assigns the IP address to the UE. The IP address of the UE may change, but the change remains within the range of the pre-pooled IP address of the UPF to which it belongs.

Here, if UE capable of communicating with UE belonging to another private network is assigned to the UPF 1, the other private network may perform the IP filter with an IP address in the address range of the UPF 1. UEs belonging to the UPF 2 and the UPF 3 are blocked by the IP filtering of another private network because the IP address is not accepted by the IP filtering.

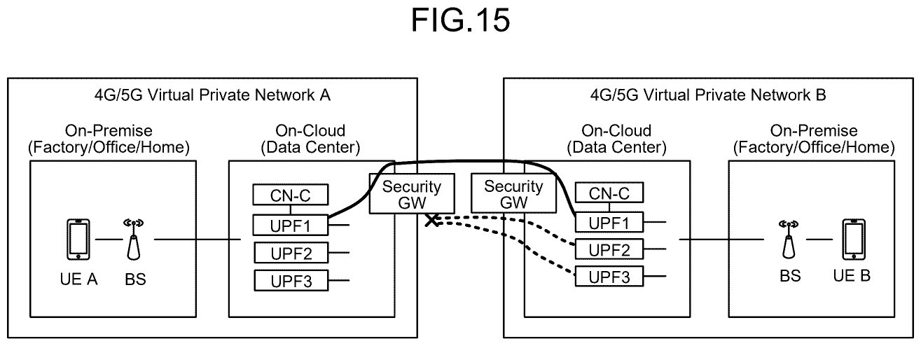

Hereinafter, the operation of the communication system 1 according to the first solution of the second embodiment will be described with reference to the drawings. FIG. 15 is a diagram illustrating an example of the operation of the communication system 1 of the second embodiment. In the example of FIG. 15, the private network A and the private network B are connected by secure communication (for example, a VPN tunnel).

Each of the private network A and the private network B has a plurality of UPFs (UPF 1 to UPF 3).

In the example of FIG. 15, the private network A has three UPFs of UPF 1 to UPF 3. IP address pools of different IP address ranges are assigned to the three UPFs, respectively. The assignment of the IP address pool to the three UPFs of the private network A is, for example, as follows:
UPF1: 192.168.0.1-192.168.0.100
UPF2: 192.168.0.101-192.168.0.200
UPF3: 192.168.0.201-192.168.0.300

The private network B also has three UPFs of UPF 1 to UPF 3 similarly to the private network A. IP address pools of different IP address ranges are assigned to the three UPFs, respectively. The assignment of the IP address pool to the three UPFs of the private network B is, for example, as follows:
UPF1: 192.168.1.1-192.168.1.100
UPF2: 192.168.1.101-192.168.1.200
UPF3: 192.168.1.201-192.168.1.300

It should be noted that, in the UPF of the private network A and the UPF of the private network B, the IP address range of the IP address pool is different even if the number of the UPF is the same. This is because the private IP addresses assigned in the two private networks need to be different in order to connect the two closed networks operating with the private IP addresses.

In the example of FIG. 15, the UE A belongs to the private network A, and the UE B belongs to the private network B. The UE A is assigned to the UPF 1 of private network B, and the UE B is assigned to the UPF 1 of private network B.

In addition, a security gateway (GW) is disposed in the private network A and the private network B. The security GW has a function of IP filtering. The security gateway (GW) checks whether or not the source IP address of the packet arriving from the private network B is within a range accepted to enter in advance. Specifically, the security GW of the private network A checks whether the source IP address of the packet arriving from the private network B is in the range of the IP address (192.168.1.1-192.168.1.100) of the IP address pool assigned to the UPF 1 of the private network B. The security GW accepts the IP packet if it is within the range, and discards the IP packet if it is out of the range.

Even if the IP address of the UE B is reassigned and changed, because it is within the range of the IP address pool of the UPF 1 of the private network B, the security GW of the private network A can accept the packet from the UE B. If the UE belonging to the UPF 2 or the UPF 3 transmits a packet to the private network A, the packet is discarded.

It is desirable to statically set the IP filter in the security GW in advance rather than frequently. In the example of FIG. 15, each of the two private networks has a plurality of UPFs. The packet transmitted from each UPF passes through the VPN tunnel and reaches the security GW on the counterpart side. The IP filter may be implemented in either security GW, but the communication path itself exists.

FIG. 15 illustrates a state in which a packet from the private network B travels to the private network A and is IP-filtered by the security GW on the private network A side. In the example of FIG. 15, only a packet from the UPF 1 of the private network B is allowed to enter the private network A.

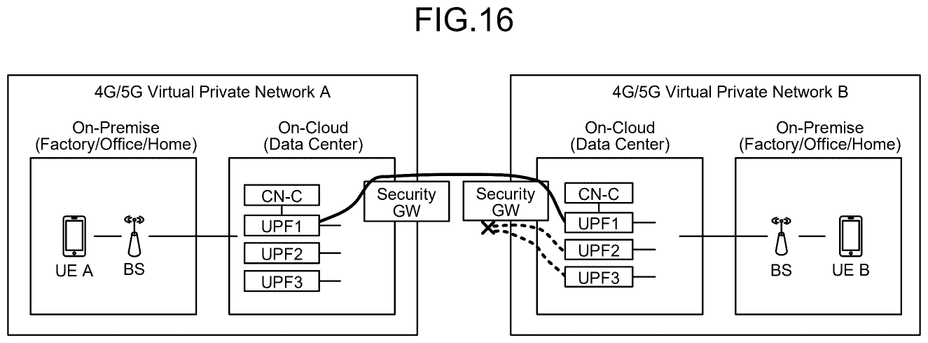

FIG. 16 is a diagram illustrating another example of the operation of the communication system 1 of the second embodiment. FIG. 16 illustrates a state of a packet from the private network B in the security GW on the private network B side. In the example of FIG. 16, only a packet from the UPF 1 of the private network B is allowed to proceed from the private network B toward the private network A.

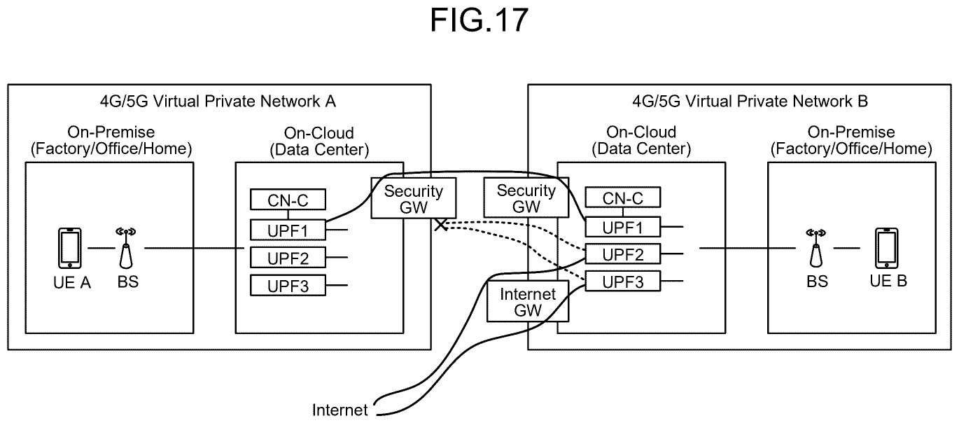

As illustrated in FIGS. 15 and 16, the IP filter is applied to a packet traveling from the private network B to the private network A. However, packets exiting from the private network B to the Internet need to pass. Therefore, a GW for the Internet is prepared in the private network B separately from the security GW. In the following description, a GW for the Internet is referred to as an Internet GW (IGW). FIG. 17 is a diagram illustrating another example of the operation of the communication system 1 of the second embodiment. FIG. 17 illustrates a state in which a packet going out to the Internet goes out to an external network through the IGW.

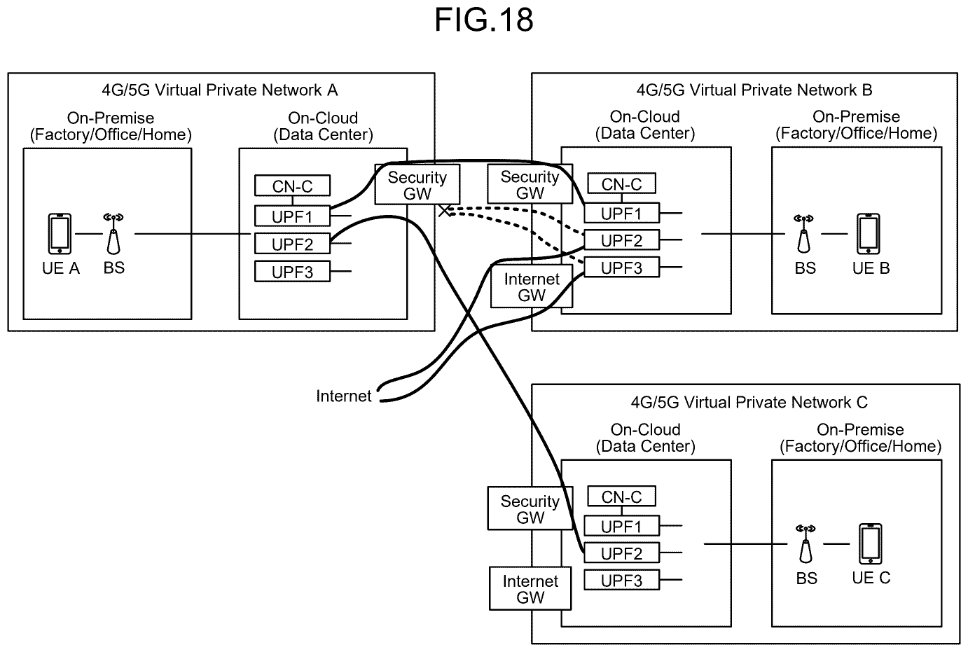

It is also assumed that a node of the private network A communicates with not only a node of the private network B but also a node of a private network different from the private network B. FIG. 18 is a diagram illustrating another example of the operation of the communication system 1 of the second embodiment. In the example of FIG. 18, the private network A is connected not only to the private network B but also to the private network C by secure communication (for example, a VPN tunnel).

The private network C also has three UPFs of UPF 1 to UPF 3 similarly to the private network A. IP address pools of different IP address ranges are assigned to the three UPFs, respectively. The assignment of the IP address pool to the three UPFs of the private network C is, for example, as follows:
UPF1: 192.168.2.1-192.168.2.100
UPF2: 192.168.2.101-192.168.2.200
UPF3: 192.168.2.201-192.168.2.300

It should be noted that the IP address range of the IP address pool assigned to the UPF of the private network C is different from the IP address range of the IP address pools assigned to the UPF of the private networks A and B.

In the example of FIG. 18, the node of the private network A can communicate not only with the node of the private network B but also with the node of the private network C. In this case, the node of the private network A (for example, UE) that communicates with the node of the private network C (UE/AF) may be assigned to a UPF 2 different from the UPF 1 provided for communication with the node of the private network B. The node of the private network C (for example. UE) may also be assigned to the UPF 2 prepared for communication with the node of the private network A (UE/AF).

At this time, conditions of a plurality of IP filters for the private network B and the private network C are set in the security GW of the private network A. The security GW of the private network A checks whether the source IP address of the packet arriving from the private network B is in the range of the IP address (192.168.1.1-192.168.1.100) of the IP address pool assigned to the UPF 1 of the private network B. In addition, the security GW of the private network A checks whether the source IP address of the packet arriving from the private network C is in the range of the IP address (192.168.2.101-192.168.2.200) of the IP address pool assigned to the UPF 2 of the private network C. The security GW accepts the IP packet if it is within the ranges, and discards the IP packet if it is out of the ranges.

In the present embodiment, the private network has a plurality of UPFs. Each of the plurality of UPFs is associated with a different IP address pool. Each of the plurality of UPFs is used in different use cases. It has a special role of handling traffic connecting some of the plurality of UPFs and other private networks. The IP address pool assigned to the UPF having the special role is used for the IP filter. The use case itself of being connected to another private network can be grasped in the form of a network slice. For example, a network slice to connect to another private network is prepared. Then, some UPFs of the plurality of UPFs are given a special role of handling communication using the network slice.

Here, a relationship between the PNAM described in the first embodiment and the PNAM described in the second embodiment will be described. The PNAM of the first embodiment was intended to enable private network A and private network B to be connected only when really needed. The PNAM of the second embodiment is intended to enable communication between nodes that really want to be accepted to communicate in a connected private network. In the second embodiment, an IP address range associated with an IP address pool assigned to the UPF is set in the security GW. The PNAM may manage this setting, but another management function may manage this setting. For example, the management devices 10 of the private networks may cooperate to implement the function as the PNAM. Note that the PNAM of the second embodiment may have the function of the PNAM of the first embodiment.

According to the present solution, IP filtering can be effectively performed even when the IP address of the accepted UE is changed. Therefore, a security threat is reduced.

### 5-3. Second Solution

In the first solution of the second embodiment, the security GW is configured to filter a source IP address. However, in this case, it is possible to transmit a packet from the UPF to which the accepted UE belongs to toward the UPF whose communication is not accepted. For example, referring to FIG. 17, the UE B belonging to the UPF 1 of the private network B can transmit the packet not only to the node assigned to the UPF 1 of the private network A but also to the nodes assigned to the UPFs 2 and 3 of the private network A. Therefore, the method of the first solution may leave a security threat.

Therefore, in the second solution, the PNAM notifies the security GW to perform the IP filtering based on the information of the IP address range associated with the IP address pool set in the source UPF (Source IP Address) and the information of the IP address range associated with the IP address pool set in the destination UPF (Destination IP Address) so that the IP packet communication can be performed only from the accepted UPF to the accepted UPF. For example, if packet transmission from the node of the UPF 1 of the private network B to the node of the UPF 1 of the private network A is accepted, the PNAM notifies the security GW of the private network A (or the security GW of the private network B) to perform IP filtering based on information of an IP address range (192.168.0.1-192.168.0.100) associated with the IP address pool set in the UPF 1 of the private network A and information of an IP address range (192.168.1.1-192.168.1.100) associated with the IP address pool set in the UPF 1 of the private network B.

Then, the security GW filters both the source IP address and the destination IP address on the basis of the information from the PNAM. For example, the security GW of the private network A (or the security GW of the private network B) checks whether or not the source IP address is in an IP address range (192.168.1.1-192.168.1.100) associated with the IP address pool set to the UPF 1 of the private network B, and checks whether or not the destination IP address is in an IP address range (192.168.0.1-192.168.0.100) associated with the IP address pool set to the UPF 1 of the private network A.

As a result, only the IP packet related to communication from the node associated with the UPF 1 of the private network B to the node associated with the UPF 1 of the private network A is allowed to enter the private network A. The source IP address and the destination IP address may be checked by the security GW of the sender-side private network. However, in the normal state, it is desirable to check the source IP address and the destination IP address in the security GW of the receiver-side private network. This is because, when the security GW of the sender-side private network checks an outgoing IP packet, there is a disadvantage that an IP packet going out to the normal Internet is also filtered.

According to the present solution, it is possible to discard a packet other than a packet that arrives at an accepted UPF and that is from the accepted UPF, so that a security threat is reduced.

Note that the PNAM may notify the security GW to perform the IP filtering not using the information of the IP address range associated with the IP address pool set in the source UPF (Source IP Address) but based on the information of the IP address range associated with the IP address pool set in the destination UPF (Destination IP Address). The security GW may then filter the destination IP address based on the information from the PNAM. Even with such a configuration, security threats can be reduced.

### 5-4. Third Solution

The solutions described in <5-2. First Solution> and <5-3. Second Solution> above are also applicable to the 5G case.

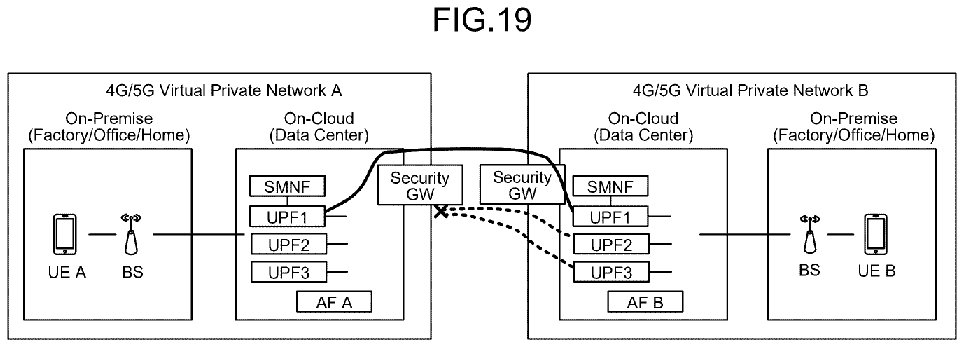

FIG. 19 is a diagram illustrating another example of the operation of the communication system 1 of the second embodiment. In the 5G core, a network function called UPF is provided instead of the SGW and the PGW. Instead of the PGW, a control plane network function called session management function (SMF) plays a role of assigning the IP address. Placing a plurality of UPFs as in 4G can also enhance the UPF's capability for rapidly increasing traffic and prepare the UPF to which certain critical UEs belong. At this time, the SMF can also assign different IP address ranges for each UPF. Therefore, the IP filtering may be performed for each IP address range assigned to the UPF similarly to the first solution and the second solution.

Note that, even when there is one UPF, in a case where an IP address can be assigned to the UE from a specific IP address pool as a function of a session management network function (SMNF), IP filtering may be performed for each specific IP address pool.

Even in 5G, it is possible to reduce a security threat by performing IP filtering in association with a specific IP address pool.

### 5-5. Fourth Solution

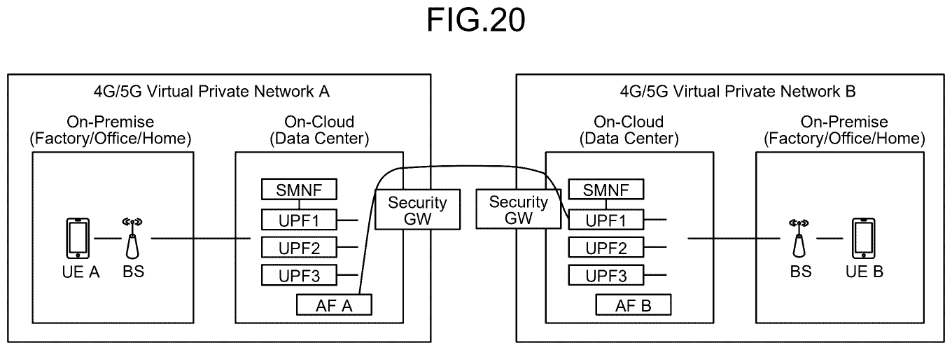

The node that performs the closed network communication is not limited to the UE. At least one node that performs the closed network communication may be an application function (AF). FIG. 20 is a diagram illustrating another example of the operation of the communication system 1 of the second embodiment. In the private network, an AF can be arranged as illustrated in FIG. 20.

FIG. 20 illustrates how the AF of the private network A communicates with UE B of the private network B. In this case, the UE B may change the IP address frequently. However, there is a case where it is desired to perform IP filtering by the AF. In this case, it is necessary to determine the range of the IP address of the AF. Because it is not the SMF but the cloud system that assigns the IP address to the AF, the assignment of the IP address is determined inside the cloud so as to assign different IP address pools. Among them, the range of the IP address assigned to an AF that can communicate with the outside may be determined. This will be different from the IP address pool of the UE. The IP address for an internal AF is blocked by an IP filter. This is because the AF is used for communication inside one private network.

The assignment of the IP address pool to the plurality of nodes (UE/AF) of the private network A is, for example, as follows: Here, the internal AF is an AF that communicates with nodes inside the private network, and the external AF is an AF that communicates with nodes in other private networks.
UPF1: 192.168.0.1-192.168.0.100
UPF2: 192.168.0.101-192.168.0.200
UPF3: 192.168.0.201-192.168.0.300
For internal AF: 192.168.0.301-192.168.0.400
For external AF: 192.168.0.401-192.168.0.500

The assignment of the IP address pool to the plurality of nodes (UE/AF) of the private network B is, for example, as follows: Here, the internal AF is an AF that communicates with nodes inside the private network, and the external AF is an AF that communicates with nodes in other private networks.
UPF1: 192.168.1.1-192.168.1.100
UPF2: 192.168.1.101-192.168.1.200
UPF3: 192.168.1.201-192.168.1.300
For internal AF: 192.168.1.301-192.168.1.400
For external AF: 192.168.1.401-192.168.1.500

The PNAM notifies the security GW to perform IP filtering by using, for example, two of the IP address pool assigned by the SMF and the IP address pool assigned by the cloud. The security GW performs IP filtering by using two of the IP address pool assigned by the SMF and the IP address pool assigned by the cloud.

According to the present solution, only secure UE and secure AF can transmit packets to nodes in the private network, thereby reducing security threats.

### 6. Modification

The above-described embodiments are examples, and various modifications and applications are possible.

For example, in the above-described embodiment, the plurality of 4G/5G private networks connected by the VPN tunnel is exemplified as the “plurality of non-public cellular closed networks connected by secure communication”. However, the “plurality of non-public cellular closed networks connected by secure communication” is not limited thereto, and may be, for example, a “plurality of 4G/5G private networks configured to perform cryptographic communication”.

The control device that controls the management device 10, the base station 20, the terminal device 30, or the network management device 40 of the present embodiment may be realized by a dedicated computer system or may be realized by a general-purpose computer system.

For example, a communication program for executing the above-described operation is distributed in the form of being stored in a computer-readable recording medium such as an optical disk, a semiconductor memory, a magnetic tape, or a flexible disk. Then, for example, the program is installed in a computer, and the above-described processing is executed to configure the control device. At this time, the control device may be an external device of the management device 10, the base station 20, or the terminal device 30 (for example, a personal computer). Furthermore, the control device may be a device inside the management device 10, the base station 20, the terminal device 30, and the network management device 40 (for example, the controller 13, the controller 23, the controller 33, or the controller 43).

Further, the above-mentioned communication program may be stored in a disk device provided in a server device on a network such as the Internet in such a way to be downloaded to a computer. Further, the above-mentioned functions may be implemented by cooperation between an operating system (OS) and application software. In this case, other parts than OS may be stored in a medium for delivery, or other parts than OS may be stored in the server device and downloaded to a computer.

Among the processing described in the embodiments, all or a part of the processing, described as automatic processing, can be performed manually, or all or a part of the processing, described as manual processing, can be performed automatically by a known method. In addition, the processing procedures, specific names, and information including various data and parameters indicated in the document and the drawings can be arbitrarily changed unless otherwise specified. For example, various types of information illustrated in the drawings are not limited to the illustrated information.

Furthermore, the constituent elements of the individual devices illustrated in the drawings are functionally conceptual and are not necessarily configured physically as illustrated in the drawings. To be specific, the specific form of distribution and integration of the devices is not limited to the one illustrated in the drawings, and all or a part thereof can be configured by functionally or physically distributing and integrating in arbitrary units according to various loads, usage conditions, and the like. Note that this configuration by distribution and integration may be performed dynamically.

Furthermore, the embodiments described above can be appropriately combined to the extent that the processing contents do not contradict each other. Furthermore, the order of each step illustrated in the flowcharts of the above-described embodiment can be changed as appropriate.

Furthermore, for example, the present embodiment can be implemented as any configuration constituting an apparatus or a system, for example, a processor as a system large scale integration (LSI) or the like, a module using a plurality of processors or the like, a unit using a plurality of modules or the like, a set further added other functions to a unit, or the like (that is, a configuration of a part of the apparatus). Note that, in the present embodiment, the system indicates a set of a plurality of components (devices, modules (parts), etc.), and it does not matter whether or not all the components are in the same housing. Therefore, a plurality of devices housed in separate housings and connected via a network and one device in which a plurality of modules is housed in one housing are both systems.

Furthermore, for example, the present embodiment can adopt a configuration of cloud computing in which one function is shared and processed by a plurality of devices in cooperation via a network.

### 7. Conclusion

As described above, the information processing apparatus of the present embodiment (for example, the network management device 40) has a management function (PNAM) for managing closed network communication of a plurality of private networks connected by a VPN tunnel. In each of the plurality of private networks, a gateway that performs an operation related to restriction of closed network communication based on a notification from the management function is disposed. The management function notifies the gateway of at least one of the two private networks performing the closed network communication of the restriction on the closed network communication.

For example, when the management function of the network management device 40 acquires information of a request for access from a node (for example, UE or AF) belonging to one private network of the two private networks to a node (for example, UE or AF) belonging to the other private network, the management function determines whether or not to accept access according to a predetermined criterion. The information of the request for access includes, for example, an IP address of the source node. The management function then notifies the gateway of at least one of the two private networks of this determination. The gateway operates so that only a node accepted to access can perform closed network communication. For example, the gateway performs IP filtering so that an IP packet having an IP address of a source node can enter the private network. This can reduce unnecessary connections, thereby reducing security threats.

Further, a plurality of user plane functions (UPFs) in which different IP address pools are set is arranged in the private network. The plurality of IP address pools includes at least one IP address pool used for closed network communication. Then, the management function of the network management device 40 notifies the gateway to perform IP filtering based on information of an IP address range associated with an IP address pool used for closed network communication. The gateway performs IP filtering based on the notification from the management function so that only IP packets in a predetermined IP address range can enter the private network. As a result, even if an IP address of the node accepted to perform the closed network communication is changed to another IP address, the IP filtering functions as long as the IP address is within a predetermined address range. As a result, security threats can be lowered.

Although the embodiments of the present disclosure have been described above, the technical scope of the present disclosure is not limited to the embodiments described above as it is, and various modifications can be made without departing from the gist of the present disclosure. In addition, constituent elements of different embodiments and modifications may be appropriately combined.

Furthermore, the effects of the embodiments described in the present specification are merely examples and are not limited, and other effects may be provided.

Note that the present technology can also have the following configurations.

(1)

An information processing method executed by an information processing apparatus that manages closed network communication of a plurality of non-public cellular closed networks connected by secure communication,
wherein each of the plurality of non-public cellular closed networks includes a gateway that performs an operation related to restriction of the closed network communication based on a notification from the information processing apparatus,
the method comprising the step of:
by the information processing apparatus,
notifying the gateway of at least one closed network of two non-public cellular closed networks performing the closed network communication of restriction of the closed network communication.
   (2)

The information processing method according to (1), further comprising the steps of:
in a case where information of a request for access from a first node belonging to one closed network of the two non-public cellular closed networks to a second node belonging to another closed network is acquired, making a decision on whether or not to accept the access according to a predetermined criterion, and
notifying the gateway of at least one closed network of the two non-public cellular closed networks of the decision.
   (3)

The information processing method according to (2), further comprising the step of:
making a decision on whether or not to accept access from the first node to the second node based on first connection acceptance information in which information on a node accepted to connect to a predetermined node is recorded.
   (4)

The information processing method according to (3), further comprising the step of:
by the information processing apparatus, further making a decision on whether or not to accept access from the first node to the second node based on second connection acceptance information in which information on a closed network accepted to connect to a predetermined closed network is recorded.
   (5)

The information processing method according to (3), further comprising the step of:

by the information processing apparatus, further making a decision on whether or not to accept access from the first node to the second node based on third connection acceptance information in which information on a combination of a node accepted to connect to a predetermined node and a closed network is recorded.

(6)

The information processing method according to any one of (2) to (5), further comprising the step of:

in a case where a predetermined condition is satisfied after the one closed network and the other closed network are connected, disconnecting the one closed network and the other closed network.

(7)

The information processing method according to (6), further comprising the step of:
disconnecting the one closed network and the other closed network after a certain period of time since there is no communication across the one closed network and the other closed network.
   (8)

The information processing method according to (6), further comprising the step of:
after the one closed network and the other closed network are connected, disconnecting the one closed network and the other closed network after a certain period of time regardless of presence or absence of communication across the one closed network and the other closed network.
   (9)

The information processing method according to (6), further comprising the step of:
disconnecting the one closed network and the other closed network when receiving a notification of termination of all communication across the one closed network and the other closed network.
   (10)

The information processing method according to any one of (2) to (9), wherein
the node is user equipment (UE) or an application function (AF).
   (11)

The information processing method according to (1), wherein
the gateway is configured to perform IP filtering based on a notification from the information processing apparatus, and
a plurality of IP address pools including an IP address pool used for closed network communication is assigned to the non-public cellular closed network, and
the information processing apparatus notifies the gateway to perform the IP filtering based on information of an IP address range associated with an IP address pool used for the closed network communication.
   (12)

The information processing method according to (11), wherein
the non-public cellular closed network includes a plurality of user plane functions (UPFs) in which different IP address pools are set.
   (13)

The information processing method according to (12), wherein
a part of the plurality of UPFs is a UPF prepared for a node using the part of the UPFs to perform closed network communication, and
another UPF of the plurality of UPFs is a UPF prepared for a node using the other UPF to perform closed-network communication.
   (14)

The information processing method according to (13), wherein
the node is user equipment (UE).
   (15)

The information processing method according to any one of (12) to (14), wherein
the gateway is configured to filter a source IP address, and
the information processing apparatus notifies the gateway to perform the IP filtering based on information of an IP address range associated with an IP address pool set in a source UPF.
   (16)

The information processing method according to any one of (12) to (14), wherein
the gateway is configured to filter a destination IP address, and
the information processing apparatus notifies the gateway to perform the IP filtering based on information of an IP address range associated with an IP address pool set in a destination UPF.
   (17)

The information processing method according to any one of (12) to (14), wherein
the gateway is configured to filter both a source IP address and a destination IP address, and
the information processing apparatus notifies the gateway to perform the IP filtering based on information of an IP address range associated with an IP address pool set in a source UPF and information of an IP address range associated with an IP address pool set in a destination UPF.
   (18)

The information processing method according to any one of (11) to (17), wherein
the non-public cellular closed network includes an application function (AF), and
the plurality of IP address pools includes an IP address pool prepared for the AF.
   (19)

An information processing apparatus comprising
a management function that manages closed network communication of a plurality of non-public cellular closed networks connected by secure communication,
wherein each of the plurality of non-public cellular closed networks includes a gateway that performs an operation related to restriction of the closed network communication based on a notification from the management function, and
the management function
notifies the gateway of at least one closed network of two non-public cellular closed networks performing the closed network communication of restriction of the closed network communication.
   (20)

An information processing system comprising:
an information processing apparatus that manages closed network communication of a plurality of non-public cellular closed networks connected by secure communication; and a gateway disposed in each of the plurality of non-public cellular closed networks, wherein
the information processing apparatus notifies the gateway of at least one closed network of two non-public cellular closed networks performing the closed network communication of restriction of the closed network communication, and
the gateway performs an operation related to restriction of the closed network communication based on a notification from the information processing apparatus.

### REFERENCE SIGNS LIST

1 COMMUNICATION SYSTEM
10 MANAGEMENT DEVICE
20 BASE STATION
30 TERMINAL DEVICE
40 NETWORK MANAGEMENT DEVICE
11, 41 COMMUNICATION UNIT
21, 31 WIRELESS COMMUNICATION UNIT
12, 22, 32, 42 STORAGE UNIT
13, 23, 33, 43 CONTROLLER
211, 311 TRANSMISSION PROCESSING UNIT
212, 312 RECEPTION PROCESSING UNIT
213, 313 ANTENNA

1. An information processing method executed by an information processing apparatus that manages closed network communication of a plurality of non-public cellular closed networks connected by secure communication,
wherein each of the plurality of non-public cellular closed networks includes a gateway that performs an operation related to restriction of the closed network communication based on a notification from the information processing apparatus,
the method comprising the step of:
by the information processing apparatus,
notifying the gateway of at least one closed network of two non-public cellular closed networks performing the closed network communication of restriction of the closed network communication.

2. The information processing method according to claim 1, further comprising the steps of:
in a case where information of a request for access from a first node belonging to one closed network of the two non-public cellular closed networks to a second node belonging to another closed network is acquired, making a decision on whether or not to accept the access according to a predetermined criterion, and
notifying the gateway of at least one closed network of the two non-public cellular closed networks of the decision.

3. The information processing method according to claim 2, further comprising the step of:
making a decision on whether or not to accept access from the first node to the second node based on first connection acceptance information in which information on a node accepted to connect to a predetermined node is recorded.

4. The information processing method according to claim 3, further comprising the step of:
by the information processing apparatus, further making a decision on whether or not to accept access from the first node to the second node based on second connection acceptance information in which information on a closed network accepted to connect to a predetermined closed network is recorded.

5. The information processing method according to claim 3, further comprising the step of:
by the information processing apparatus, further making a decision on whether or not to accept access from the first node to the second node based on third connection acceptance information in which information on a combination of a node accepted to connect to a predetermined node and a closed network is recorded.

6. The information processing method according to claim 2, further comprising the step of:
in a case where a predetermined condition is satisfied after the one closed network and the other closed network are connected, disconnecting the one closed network and the other closed network.

7. The information processing method according to claim 6, further comprising the step of:
disconnecting the one closed network and the other closed network after a certain period of time since there is no communication across the one closed network and the other closed network.

8. The information processing method according to claim 6, further comprising the step of:
after the one closed network and the other closed network are connected, disconnecting the one closed network and the other closed network after a certain period of time regardless of presence or absence of communication across the one closed network and the other closed network.

9. The information processing method according to claim 6, further comprising the step of:
disconnecting the one closed network and the other closed network when receiving a notification of termination of all communication across the one closed network and the other closed network.

10. The information processing method according to claim 2, wherein
the node is user equipment (UE) or an application function (AF).

11. The information processing method according to claim 1, wherein
the gateway is configured to perform IP filtering based on a notification from the information processing apparatus, and
a plurality of IP address pools including an IP address pool used for closed network communication is assigned to the non-public cellular closed network, and
the information processing apparatus notifies the gateway to perform the IP filtering based on information of an IP address range associated with an IP address pool used for the closed network communication.

12. The information processing method according to claim 11, wherein
the non-public cellular closed network includes a plurality of user plane functions (UPFs) in which different IP address pools are set.

13. The information processing method according to claim 12, wherein
a part of the plurality of UPFs is a UPF prepared for a node using the part of the UPFs to perform closed network communication, and
another UPF of the plurality of UPFs is a UPF prepared for a node using the other UPF to perform closed-network communication.

14. The information processing method according to claim 13, wherein
the node is user equipment (UE).

15. The information processing method according to claim 12, wherein
the gateway is configured to filter a source IP address, and
the information processing apparatus notifies the gateway to perform the IP filtering based on information of an IP address range associated with an IP address pool set in a source UPF.

16. The information processing method according to claim 12, wherein
the gateway is configured to filter a destination IP address, and
the information processing apparatus notifies the gateway to perform the IP filtering based on information of an IP address range associated with an IP address pool set in a destination UPF.

17. The information processing method according to claim 12, wherein
the gateway is configured to filter both a source IP address and a destination IP address, and
the information processing apparatus notifies the gateway to perform the IP filtering based on information of an IP address range associated with an IP address pool set in a source UPF and information of an IP address range associated with an IP address pool set in a destination UPF.

18. The information processing method according to claim 11, wherein
the non-public cellular closed network includes an application function (AF), and
the plurality of IP address pools includes an IP address pool prepared for the AF.

19. An information processing apparatus comprising a management function that manages closed network communication of a plurality of non-public cellular closed networks connected by secure communication,
wherein each of the plurality of non-public cellular closed networks includes a gateway that performs an operation related to restriction of the closed network communication based on a notification from the management function, and
the management function notifies the gateway of at least one closed network of two non-public cellular closed networks performing the closed network communication of restriction of the closed network communication.

20. An information processing system comprising:
an information processing apparatus that manages closed network communication of a plurality of non-public cellular closed networks connected by secure communication; and a gateway disposed in each of the plurality of non-public cellular closed networks, wherein
the information processing apparatus notifies the gateway of at least one closed network of two non-public cellular closed networks performing the closed network communication of restriction of the closed network communication, and
the gateway performs an operation related to restriction of the closed network communication based on a notification from the information processing apparatus.
